(19) United States
(12) Patent Application Publication
(10) Pub. No.: US 2026/0299499 A1
(43) Pub. Date: Oct. 1, 2026

(54) POST-PROCESSING DEVICE, IMAGE FORMING SYSTEM, AND RUBBING COMPONENT USED IN POST-PROCESSING DEVICE AND IMAGE FORMING SYSTEM

(71) Applicant: FUJIFILM Business Innovation Corp., Tokyo (JP)

(72) Inventors: Hina SAITO, Kanagawa (JP); Toru INOUE, Kanagawa (JP); Motoharu NAKAO, Kanagawa (JP)

(73) Assignee: FUJIFILM Business Innovation Corp., Tokyo (JP)

(21) Appl. No.: 19/315,699

(22) Filed: Sep. 1, 2025

(30) Foreign Application Priority Data
Mar. 27, 2025 (JP) 2025-054030

(51) Int. Cl. G03G 15/00; D03D 15/292; D03D 15/33; D04B 1/22; D04B 21/20; G03G 9/16; G03G 15/20

(52) U.S. Cl. CPC G03G 15/6573; D03D 15/292; D03D 15/33; D04B 1/22; D04B 21/20; G03G 9/16; G03G 15/2064; G03G 15/6585; D10B 2505/00; G03G 2215/0604

(57) ABSTRACT

A post-processing device includes a transport section that transports a medium, on which an image formed using an imaging material and wax are held and which has passed through a fixing section that fixes the image of the medium by heating and pressurization, at a predetermined speed by nipping the medium, and a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section, in which the rubbing section has, at least on a surface, a rubbing portion in which fibers are arranged in a regular pattern in a direction intersecting the transport direction of the medium, and the rubbing portion comes into contact with the surface of the medium with portions of the fibers other than end portions.

### CROSS-REFERENCE TO RELATED APPLICATIONS

This application is based on and claims priority under 35 USC 119 from Japanese Patent Application No. 2025-054030 filed Mar. 27, 2025.

### BACKGROUND

### (i) Technical Field

The present invention relates to a post-processing device and an image forming system using the post-processing device.

### (ii) Related Art

In the related art, as an image forming system using a toner containing wax or a post-processing device used in the image forming system, for example, an image forming system and a post-processing device disclosed in JP2003-98917A (Detailed Description of the Invention, FIG. 1), JP2014-48593A (Detailed Description of the Invention, FIG. 4), and JP1995-89257B (Alias: JP H7-89257B) (Examples, FIG. 1) have already been known.

JP2003-98917A (Detailed Description of the Invention, FIG. 1) discloses a removal device that removes a recorded image formed using an image forming material by a rubbing member, in which the rubbing member is a rotary brush configured with at least two kinds of wire rods having different rigidities.

JP2014-48593A (Detailed Description of the Invention, FIG. 4) discloses a cleaning device including a cleaning member that removes a fine granule on a surface of a body to be cleaned, in which the cleaning member consists of a pile fabric including a base fabric and a plurality of nap-raised cloth on the base fabric, and in a case where a fine granule diameter is denoted by D1 and a fiber diameter of the pile yarn is denoted by D2, D2/D1≤2.

JP1995-89257B (Alias: JP H7-89257B) (Examples, FIG. 1) discloses a fixing device including a roller for fixing an unfixed image and a fibrous cleaning member that comes into contact with the roller and cleans the roller, in which the cleaning member contains a metal on at least a side that comes into contact with the roller, the roller has a rubber layer as a surface layer, and the cleaning member and the roller rub against each other.

### SUMMARY

Aspects of non-limiting embodiments of the present disclosure relate to a post-processing device and an image forming system that smooth a medium by suppressing a loss of a material forming a surface portion of a rubbing section in contact with the medium and uniformly rubbing wax on the medium while transporting the medium, to make the wax on the medium less visible, as compared with a case where the surface portion of the rubbing section is made of felt or a pile fabric.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing device including: a transport section that transports a medium, on which an image formed using an imaging material and wax are held and which has passed through a fixing section that fixes the image of the medium by heating and pressurization, at a predetermined speed by nipping the medium; and a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section, in which the rubbing section has, at least on a surface, a rubbing portion in which fibers are arranged in a regular pattern in a direction intersecting the transport direction of the medium, and the rubbing portion comes into contact with the surface of the medium with portions of the fibers other than end portions.

### BRIEF DESCRIPTION OF THE DRAWINGS

Exemplary embodiment(s) of the present invention will be described in detail based on the following figures, wherein:

FIG. 1A is a diagram showing an outline of an exemplary embodiment of an image forming system including a post-processing device to which the present invention is applied, FIG. 1B is a diagram showing a representative aspect of the post-processing device shown in FIG. 1A, FIG. 1C is an arrow view from above of a rubbing section of the post-processing device shown in FIG. 1B, and FIG. 1D is a diagram showing an example of a rubbing portion of the rubbing section;

FIG. 2A is a diagram showing a disposition example of fibers constituting the rubbing portion of the rubbing section, FIG. 2B is a diagram showing a configuration example (I) and a configuration example (II) of the rubbing portion, and FIG. 2C is a diagram schematically showing a change in wax held on a medium before and after passing through the post-processing device;

FIG. 3 is a diagram showing an overall configuration of an image forming system according to Exemplary Embodiment 1;

FIG. 4A is a diagram showing a configuration example of a fixing device used in the image forming system of FIG. 3, FIG. 4B is a diagram showing a state where a medium that holds an unfixed image formed using a toner enters the fixing device, and FIG. 4C is a diagram showing a state where wax on a surface of the toner is transferred to a heating roll, which is a fixing member for heating, in a case where the medium has passed through the fixing device;

FIG. 5A is a diagram showing a state where the wax that slips through a cleaning mechanism in the wax transferred to the heating roll is transferred to a side of a pressure roll that is a fixing member for pressurization, FIG. 5B is a diagram showing a state where the wax is transferred from the heating roll and the pressure roll that are the fixing members to a front surface and a back surface of the medium in a case where a subsequent medium passes through the fixing device, and FIG. 5C is a diagram schematically showing a state where the wax transferred to the surface of the medium is solidified;

FIG. 6 is a diagram showing a major portion of a post-processing device according to Exemplary Embodiment 1;

FIG. 7 is a diagram showing a configuration example of a transport roll and a rubbing roll of the post-processing device according to Exemplary Embodiment 1;

FIG. 8A is a diagram showing a support structure example of the transport roll, and FIG. 8B is a diagram showing a retract mechanism example shown in FIG. 8A;

FIG. 9A is a diagram showing the support structure example of the rubbing roll, FIG. 9B is a diagram showing an example of a nip release mechanism shown in FIG. 9A, FIG. 9C is an arrow view taken from a C direction in FIG. 9B, and FIG. 9D is a diagram showing a configuration example of application of a contact pressure in a case of contact of the rubbing roll;

FIG. 10A is a plan view showing a configuration example of the rubbing roll, FIG. 10B is a cross-sectional view of the rubbing roll, and FIG. 10C is a diagram showing a manufacturing example of the rubbing roll;

FIGS. 11A to 11C are diagrams showing Configuration Example 1 of a rubbing portion of a rubbing roll according to Exemplary Embodiment 1;

FIG. 12A is a diagram schematically showing a rubbing portion having a woven fabric structure, and FIG. 12B is a diagram showing a rubbing operation procedure on the wax held on the medium by the rubbing portion shown in FIG. 12A;

FIG. 13A is a diagram showing a relative positional relationship between the rubbing portion having the woven fabric structure and wax W held on the medium, FIG. 13B is a cross-sectional view taken along line B-B in FIG. 13A and is a diagram showing a rubbing effect of the rubbing portion for wax W1 held on the medium, and FIG. 13C is a cross-sectional view taken along line C-C in FIG. 13A and is a diagram showing a rubbing effect of the rubbing portion for wax W2 held on the medium;

FIGS. 14A and 14B are diagrams showing a configuration example of the rubbing portion of the rubbing roll according to Exemplary Embodiment 1;

FIG. 15A is a diagram schematically showing a rubbing portion having a knitted fabric structure, and FIG. 15B is a diagram showing a rubbing operation procedure on the wax held on the medium by the rubbing portion shown in FIG. 15A;

FIG. 16A is a diagram showing a configuration example of a sea-island type microfiber that constitutes the rubbing portion, FIG. 16B is a cross-sectional view of FIG. 16A, FIG. 16C is a diagram showing a configuration example of a split type microfiber that constitutes the rubbing portion, FIG. 16D is a cross-sectional view of FIG. 16C, FIG. 16E is a diagram showing a configuration of a non-microfiber that constitutes the rubbing portion, and FIG. 16F is a cross-sectional view of FIG. 16E;

FIG. 17A is a diagram schematically showing a wax rubbing effect by the rubbing portion using fibers having an appropriate fiber diameter with respect to the wax held on the medium, and FIGS. 17B and 17C are diagrams schematically showing a wax rubbing effect by the rubbing portion using fibers having an inappropriate fiber diameter with respect to the wax held on the medium;

FIGS. 18A to 18E are diagrams showing a procedure of a post-processing operation on a medium using the post-processing device according to Exemplary Embodiment 1;

FIG. 19A is a diagram schematically showing a change state of the wax held on the medium before and after the wax passes through the post-processing device according to Exemplary Embodiment 1, FIG. 19B is a plan view of FIG. 19A viewed from above, and FIG. 19C is a diagram schematically showing a change state of wax held on a medium before and after the wax passes through a post-processing device according to Comparative Example 1;

FIG. 20 is a diagram showing a major portion of a post-processing device according to Exemplary Embodiment 2;

FIG. 21 is a diagram showing a configuration example of a transport roll and a rubbing roll of the post-processing device according to Exemplary Embodiment 2;

FIGS. 22A to 22E are diagrams showing a procedure of a post-processing operation on a medium using the post-processing device according to Exemplary Embodiment 2;

FIG. 23 is a diagram showing a drive control system of the post-processing device according to Exemplary Embodiment 3;

FIG. 24 is a diagram showing a configuration example of a transport roll and a rubbing roll of the post-processing device according to Exemplary Embodiment 3;

FIG. 25 is a flowchart showing a control processing procedure of the post-processing device according to Exemplary Embodiment 3;

FIG. 26A is a diagram schematically showing a first mode of the post-processing device according to Exemplary Embodiment 3, FIG. 26B is a diagram schematically showing a second mode of the post-processing device, and FIG. 26C is a diagram schematically showing a third mode of the post-processing device;

FIGS. 27A to 27E are diagrams showing a procedure of a post-processing operation on a medium using the post-processing device according to Exemplary Embodiment 3;

FIG. 28 is a diagram showing a major portion of a post-processing device according to Exemplary Embodiment 4;

FIG. 29A is a diagram showing an example of a microscope photograph of a surface of a medium before post-processing by a post-processing device according to Example 1, FIG. 29B is a diagram showing a distribution of wax corresponding to the microscope photograph of FIG. 29A in a 3D image and schematically showing an adhesive state of the wax on the surface of the medium, FIG. 29C is a diagram showing an example of a microscope photograph of the surface of the medium after the post-processing by the post-processing device according to Example 1, and FIG. 29D is a diagram showing a distribution of wax corresponding to the microscope photograph of FIG. 29C in a 3D image and schematically showing an adhesive state of the wax on the surface of the medium;

FIG. 30 is a graph showing a relationship between a thickness of a thin film-like layer after post-processing of wax adhering to a medium and visibility of the wax in evaluating performance of a post-processing device according to Example 2;

FIG. 31A is a diagram showing evaluation of a rubbing operation effect of a rubbing roll according to Comparative Examples 1 and 2, and FIG. 31B is a diagram showing evaluation of a rubbing operation effect of a rubbing roll according to Example 3;

FIG. 32A is a diagram showing an experimental method for checking the durability of a rubbing roll according to Example 4, FIG. 32B is a diagram showing a result of an experiment on the durability of a rubbing roll according to Example 4 at a small-sized paper passing portion, and FIG. 32C is a diagram showing a result of an experiment on the durability of the rubbing roll according to Example 4 at a large-sized paper passing portion;
(a) of FIG. 33 is a diagram showing a relationship between a fiber diameter of a cloth material used for a rubbing roll according to Example 5 and a wax transfer level to the medium, and (b) of FIG. 33 is a diagram showing a relationship between a thickness of the cloth material and the wax transfer level to the medium; and
(a) of FIG. 34 is a diagram showing a relationship between a density of the cloth material used for the rubbing roll according to Example 5 and the wax transfer level to the medium, and (b) of FIG. 34 is a diagram showing a relationship between water retention of the cloth material and the wax transfer level to the medium.

### DETAILED DESCRIPTION

### Outline of Exemplary Embodiment

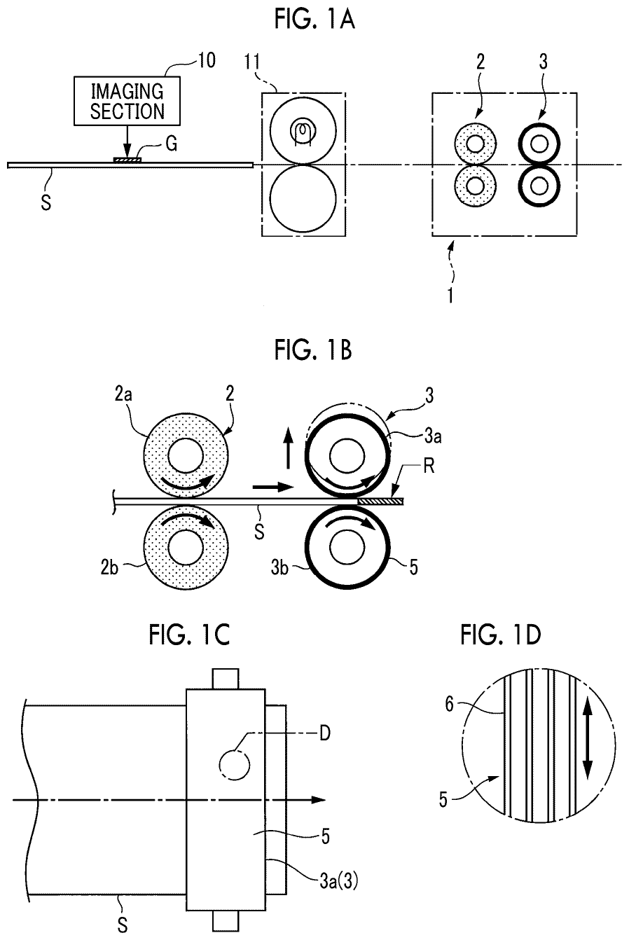

FIG. 1A shows an outline of an exemplary embodiment of an image forming system to which the present invention is applied.

In the same drawing, the image forming system includes an imaging section 10 that holds an image G formed using an imaging material containing wax on a medium S, a fixing section 11 that performs heating and pressurization to fix the image G formed by the imaging section 10 on the medium S, and a post-processing device 1 that performs post-processing on the medium S that has passed through the fixing section 11.

In the present example, as shown in FIG. 1B, the post-processing device 1 includes a transport section 2 that transports a medium S, on which an image G formed using an imaging material and wax are held and which has passed through a fixing section 13 that fixes the image G of the medium S by heating and pressurization, at a predetermined transport speed v0 by nipping the medium S, and a rubbing section 3 that is located upstream or downstream of the transport section 2 in a transport direction of the medium S and that rubs a surface of the medium S such that a layer thickness after passage of the wax held on the surface of the medium S is reduced, in a case where the medium S transported by the transport section 2 passes through the rubbing section 3, in which the rubbing section 3 has, at least on a surface, a rubbing portion 5 in which fibers 6 are arranged in a regular pattern in a direction intersecting the transport direction of the medium S, and the rubbing portion 5 comes into contact with the surface of the medium S with portions of the fibers other than end portions 6.

In FIGS. 1A and 1B, an aspect is shown in which the rubbing section 3 is disposed downstream of the transport section 2 in the transport direction of the medium S.

In such technical means, the medium S is not limited to a sheet-like medium cut into a predetermined size, and also includes a continuous medium such as a roll-like medium. The imaging section 10 need only form the image G formed using the imaging material (for example, a toner) containing the wax and hold the image G on the medium S. Representative examples thereof include an electrophotographic method and an electrostatic recording method, but the present invention is not limited to this. Here, the reason why the wax is contained in the imaging material is to ensure the mold releasability between the image G and a fixing member during the fixation using the heating and pressurization performed by the fixing section 11.

In addition, the fixing section 11 may be selected as appropriate as long as the fixing method using the heating and pressurization may be adopted. Representative examples thereof include an aspect in which a fixing member for heating and a fixing member for pressurization are disposed in a pressurized manner, and the medium S passes through a contact region between the fixing member for heating and the fixing member for pressurization. In this case, the fixing member may be selected as appropriate from a roll-like fixing member, a belt-like fixing member, and the like. As a heating method of the fixing member for heating, a heating source may be incorporated into the fixing member, or an aspect may be adopted in which the heating is performed outside the fixing member. Further, a cleaning element for cleaning the wax, paper dust, and the like transferred to the fixing member may be additionally provided in the fixing member for heating. Further, a heating source or a cleaning element may be added to the fixing member for pressurization as necessary.

Further, the post-processing device 1 is built in, for example, an image forming unit in which the imaging section 10 and the fixing section 11 are mounted. However, the present invention is not limited to this aspect, and the post-processing device 1 may be configured as an independent unit separate from the image forming unit. In this case, the post-processing device 1 may be installed alongside the image forming unit to construct the image forming system. Alternatively, the post-processing device 1 may be installed by not being alongside the image forming unit and used to perform the post-processing on the medium S that is once output from the image forming unit.

In the present example, in order for the medium S to pass through the post-processing device 1, an element for feeding the medium S and an element for taking out the medium S are provided before and after a transport path of the medium S in the post-processing device 1. The transport section 2 may be selected as appropriate as long as the transport section 2 transports the medium S at the predetermined transport speed v0 by nipping the medium S. The transport speed v0 referred to here is selected in consideration of a feeding speed of the medium S fed to the post-processing device 1 or a taking-out speed of the medium S taken out from the post-processing device 1. In addition, the transport section 2 need only include a plurality of transport members (for example, a plurality of rotating bodies 2a and 2b) that transport the medium S by nipping the medium S.

In the present example, the rubbing section 3 is located upstream or downstream of the transport section 2 in the transport direction of the medium S and is required to rub the surface of the medium S. The meaning of “surface of the medium S” referred to here is not limited to the front surface of the medium S and also includes the back surface. Therefore, an aspect is representative in which the rubbing section 3 rubs both the front and back surfaces of the medium S as rubbing targets, but a configuration is also included in which any one of the front surface or the back surface of the medium S is rubbed as the rubbing target.

As the configuration example of the rubbing section 3, the rubbing section 3 may be fixedly installed without being limited to the movable aspect as long as the rubbing section 3 has an effect of coming into contact with the medium S and rubbing the surface of the medium S.

Further, as shown in FIGS. 1B to 1D, a surface portion structure, first, the rubbing section 3 needs to include, at least on the surface, the rubbing portion 5 in which the fibers 6 are arranged in a regular pattern in the direction intersecting the transport direction of the medium S. The “direction intersecting the transport direction” referred to here is not limited to a direction orthogonal to the transport direction, and includes a direction crossing the transport direction. Further, the intersecting directions may be arranged in parallel or may be arranged non-parallel. Furthermore, the fiber 6 may be a single fiber or a plurality of fibers bundled together.

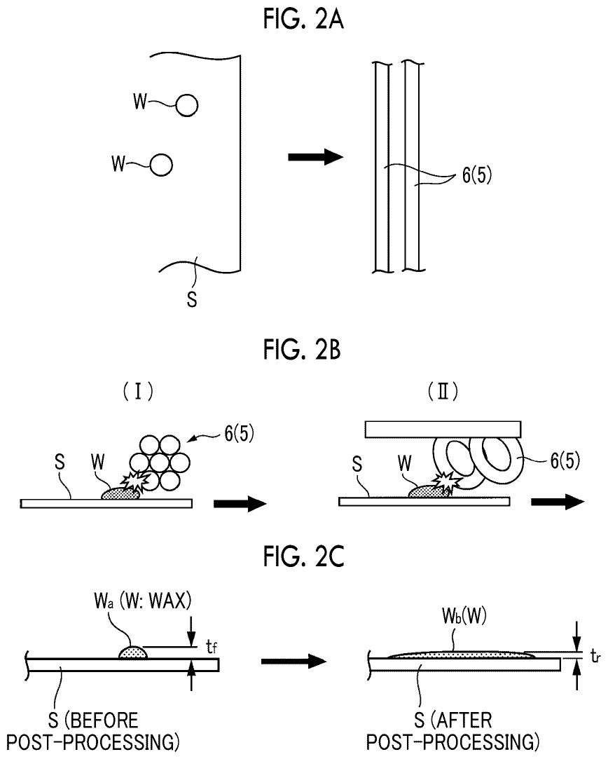

As described above, the fibers 6 are arranged in the direction intersecting the transport direction of the medium S in the rubbing portion 5 as shown in FIG. 2A. Therefore, in the present example, the wax W held on the medium S comes into contact with the fibers 6 of the rubbing portion 5 regardless of the position of the wax W in the direction intersecting the transport direction of the medium S. Therefore, the wax W held on the medium S is spread by the fibers 6 constituting the rubbing portion 5.

Second, it is necessary that portions of the fibers 6 other than the end portions come into contact with the surface of the medium S. In a case where the end portions of the fibers 5 come into contact with the surface of the medium S, there is a concern that the fibers are pulled out.

In this regard, the fibers 6 constituting the rubbing portion 5 may extend in the direction intersecting the transport direction of the medium S as shown in (I) of FIG. 2B. In this case, portions of the fibers 6 other than the end portions in the longitudinal direction come into contact with the wax W on the medium S.

In addition, as shown in (II) of FIG. 2B, the fibers 6 constituting the rubbing portion 5 need only be arranged such that loop portions of the fibers 6 woven in a loop shape are closely arranged in a regular pattern in the direction intersecting the transport direction of the medium S. In this case, the wax W on the medium S comes into contact with the portions other than the end portions of the loop portions of the fibers 6 that are closely arranged in a regular pattern in the direction intersecting the transport direction of the medium S.

Further, the rubbing operation using the rubbing section 3 may be selected as appropriate as long as a layer thickness tr after the wax W held on the surface of the medium S has passed through is equal to or less than a necessary value for making the wax W on the medium S less visible in a case where the medium S transported by the transport section 2 passes through. According to the experiment by the inventors of the present invention, it has been confirmed that the wax W is effective in making the wax W less visible in a case where the layer thickness tr of the wax W is equal to or less than 0.15 μm.

This point will be specifically described as follows. In a case where the wax W is transferred to the surface of the medium S that has passed through the fixing section 11, as shown in FIG. 2C, wax W is deformed to be rounded by the surface tension in a procedure of being cooled and solidified, and a granular mass (lump) Wa is likely to be formed. In this case, in a case where, for example, a transparent film of which the surface is smooth is used as the medium S, light is scattered by a granular mass Wa portion (layer thickness tf), and thus the granular mass Wa is whitened and visualized.

In the present example, as shown in FIG. 1B, the post-processing device 1 rubs the surface of the medium S by the rubbing section 3. Therefore, in a rubbing region R rubbed by the rubbing section 3, the wax W in the granular mass Wa can be smoothed to form a thin film-like layer Wb. Here, in a case where the layer thickness tr (tr<tf) of the thin film-like layer Wb is selected to an appropriate level, the visualization phenomenon of the wax W due to the scattering of the transmitted light or the reflected light on the medium S is reduced, and the wax on the medium S is less visible.

Next, a representative aspect or a desired aspect of the post-processing device 1 according to the present exemplary embodiment will be described.

First, as a representative aspect of the rubbing section 3, there is an aspect in which the rubbing section 3 includes, at least on the surface, the rubbing portion 5 in which one or a plurality of fibers 6 extending in the direction intersecting the transport direction of the medium S are arranged in a regular pattern, and the rubbing portion 5 comes into contact with the surface of the medium S with the portions of the fibers 6 extending in the length direction.

As a desired aspect of the present example, there is an aspect in which the rubbing section 3 includes, at least on the surface, the rubbing portion 5 in which fiber bundles each formed by bundling a plurality of fibers 6 extending in the direction intersecting the transport direction of the medium S are arranged in a regular pattern, and the rubbing portion 5 comes into contact with the surface of the medium S with the plurality of fibers 6 of the fiber bundle. In the present example, the number of times of rubbing operation on the wax W is larger than the number of times of rubbing operation in a case where one fiber 6 comes into contact with the surface of the medium S, and accordingly, for example, this configuration is preferable in that the rubbing performance of the rubbing portion 5 is improved.

In addition, another representative aspect of the rubbing section 3, there is an aspect in which the rubbing section 3 includes, at least on the surface, a rubbing portion 5 in which loop-shaped fibers 6 are closely arranged in a regular pattern in the direction intersecting the transport direction of the medium S, and the rubbing portion 5 comes into contact with the surface of the medium S with protruding end portions of the loop-shaped fibers 6.

As a desired aspect of the present example, for example, an aspect is preferable in which the rubbing section 3 includes, at least on the surface, the rubbing portion 5 in which a plurality of rows of loop-shaped fibers 6 are alternately and closely arranged in a regular pattern in the direction intersecting the transport direction of the medium S, and the rubbing portion 5 comes into contact with the surface of the medium S with protruding end portions of at least two rows of loop-shaped fibers 6. In the present example as well, the number of rubbing operations on the wax W is larger than the number of rubbing operations in a case where one row of the loop-shaped fibers 6 comes into contact with the surface of the medium S, and accordingly, for example, this configuration is preferable in that the rubbing performance of the rubbing portion 5 is improved.

In addition, as a desired aspect of the rubbing section 3, there is an aspect in which the rubbing section 3 is elastically biased against the medium S. In the present example, the rubbing section 3 may be biased by an elastic member. Further, the rubbing portion 5 may be provided on a substrate via an elastic layer. In the present example, for example, this configuration is preferable in that the contact state between the medium S and the rubbing portion 5 may be maintained in a good state even in a case where the fibers 6 of the rubbing portion 5 are slightly worn due to a temporal change in the rubbing section 3.

Further, as a representative aspect of the rubbing section 3, there is an aspect in which the rubbing section 3 includes the rubbing portion 5 having a knitted fabric structure composed of continuous meshes. The present example is an example of an aspect in which the rubbing portion 5 comes into contact with the surface of the medium S with the portions of the fibers 6 extending in the length direction. In addition, the rubbing section 3 may include the rubbing portion 5 having a woven fabric structure woven by combining yarns each consisting of warp and weft fibers. The present example is an example of an aspect in which the protruding end portions of the loop-shaped fibers 6 come into contact with the surface of the medium S.

In addition, as a desired aspect of the rubbing section 3, there is an aspect in which a fiber diameter is larger than a wax height before the post-processing. In a case where the fiber diameter is smaller than the wax height, there is a possibility that the effect of rubbing the wax W held on the medium S may be difficult.

Further, as a desired aspect of the rubbing section 3, there is an aspect in which the fiber diameter is smaller than a wax length before the post-processing. The “wax length” referred to here is a length of the wax W on the medium S in a direction along the transport direction of the medium S. In a case where the fiber diameter is larger than the wax length before the post-processing, the entire wax W held on the medium S is less likely to be rubbed.

Further, as another desired aspect of the rubbing section 3, for example, an aspect is preferable in which the rubbing section 3 includes the rubbing portion 5 consisting of microfibers having a fiber diameter of less than 10 μm. Compared with the non-microfibers, the rubbing effect can be stably applied to the entire wax W held on medium S.

In addition, as a representative configuration example of the rubbing section 3, there is an aspect in which the rubbing section 3 includes a rotating body that is disposed to face the medium S and a belt-shaped member that is wound in a spiral shape around the rotating body, and the belt-shaped member has the rubbing portion 5 formed in advance on a surface side. In this case, for example, a belt-shaped member including the rubbing portion 5 consisting of a woven fabric structure or a knitted fabric structure using the fibers 6 may be used.

In addition, in the present example, as a representative aspect of the rubbing section 3, there is an aspect in which the rubbing section 3 consists of a plurality of rotating bodies 3a and 3b that are disposed to face each other with respect to the medium S and that are able to come into contact with each other and separable from each other between a contact position at which the plurality of rotating bodies 3a and 3b are in contact with the medium S and a non-contact position, and rubs the surface of the medium S in a case where the plurality of rotating bodies 3a and 3b are disposed at the contact position.

In this case, for example, it is preferable that, in a case where the plurality of rotating bodies 3a and 3b constituting the rubbing section 3 are disposed at the contact position, a frictional force between the transport section 2 and the medium S is greater than a frictional force between the rubbing section 3 and the medium S.

In addition, for example, it is preferable that the plurality of rotating bodies 3a and 3b constituting the rubbing section 3 are disposed at the contact position in a case where the transport section 2 transports the medium S, and are disposed at the non-contact position in a case where the transport section 2 does not transport the medium S.

Hereinafter, the present invention will be described in more detail based on the exemplary embodiments shown in the accompanying drawings.

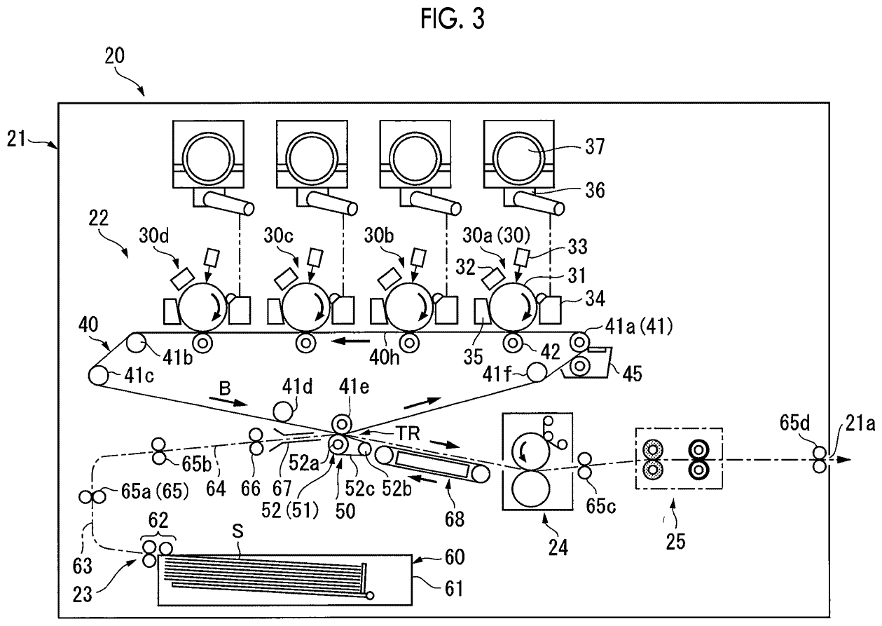

FIG. 3 shows an overall configuration of an image forming system according to Exemplary Embodiment 1.

### Overall Configuration of Image Forming System

In the same drawing, an image forming system 20 includes a unit housing 21 having a required external appearance shape. Major elements such as an imaging engine 22, a medium transport system 23, a fixing device 24, and a post-processing device 25 are mounted in an internal space of the unit housing 21.

### Imaging Engine

In the present example, the imaging engine 22 corresponds to the imaging section 10 shown in FIGS. 1A and 1B.

In FIG. 2, the imaging engine 22 includes a plurality of (four in the present example) image forming portions 30 (specifically, 30a to 30d) that form images of a plurality of (four in the present example) color components, an intermediate transfer body 40 that sequentially performs primary transfer of the images of the respective color components formed by the plurality of image forming portions 30 to hold the images, and that transports the images to a position for the transfer to the medium, and a transfer device 50 that performs secondary (batch) transfer of the images of the respective color components held by the intermediate transfer body 40 to the medium.

In the present example, the respective image forming portions 30 (30a to 30d) form the images of the respective color components of yellow (Y), magenta (M), cyan (C), and black (K). The arrangement of the image forming portions 30 may be changed as appropriate, and it goes without saying that a portion that forms the image of another color component (white, transparent, spot color of special color component, or the like) may also be included in the plurality of image forming portions 30. In the present example, the image forming portion 30 is configured to form the images of a plurality of color components, but may form, for example, a monochromatic image of only black (K). Further, in the present example, the imaging engine 22 forms the image on the medium via the intermediate transfer body 40, but the imaging engine 22 may directly form the image on the medium without passing through the intermediate transfer body 40.

### Image Forming Portion

In the same drawing, each of the image forming portions 30 (30a to 30d) adopts an electrophotographic method. In the present example, each of the image forming portions 30 (30a to 30d) has a photoconductor 31 that rotates in a predetermined direction. Then, devices such as a charger 32, an exposure device 33, a developing device 34, and a cleaning device 35 are disposed in order around the photoconductor 31.

Here, the photoconductor 31 is formed in, for example, a drum shape and has a photosensitive layer serving as an image forming surface and an image holding surface, on a surface thereof. In addition, the charger 32 charges an outer peripheral surface of the photoconductor 31 to a required surface potential. As the charger 32, for example, a non-contact charging method using a corona discharge or a contact charging method using a charging roll is adopted.

Further, the exposure device 33 irradiates the outer peripheral surface of the photoconductor 31 with light in accordance with image information to form an electrostatic latent image for each color component image. As the exposure device 33, a light irradiation device such as a laser scanner or an LED array is used. In the present example, the exposure device 33 is individually provided for each of the image forming portions 30 (30a to 30d), but a part or all of the exposure devices 33 may be commonly used.

In addition, the developing device 34 uses a developer containing each color component toner as an example of the imaging material, and develops each electrostatic latent image on the photoconductor 31 as an image formed using each color component toner. The toner in the developer contains an appropriate amount of wax. This wax is mostly used to ensure the mold releasability between the fixing member of the fixing device 24 and the image on the medium. Further, a toner replenishing mechanism 36 is provided in an upper space portion of the developing device 34 of each image forming portion 30, and is connected to each developing device 34 in communication. A toner cartridge 37 including a container that accommodates a toner for replenishment is attachably and detachably provided in each toner replenishing mechanism 36.

In addition, the cleaning device 35 is provided downstream of a primary transfer portion of the photoconductor 31 to the intermediate transfer body 40 in a rotation direction of the photoconductor 31. The cleaning device 35 cleans the residues such as the toner remaining on the photoconductor 31 after the primary transfer.

In the present example, the electrophotographic method using the photoconductor 31 and the exposure device 33 is adopted, but the present invention is not limited to this, and it goes without saying that the electrostatic recording method using a dielectric and an ion flow recorder may be adopted.

### Intermediate Transfer Body

In the present example, the intermediate transfer body 40 consists of, for example, an endless belt member made of a polyimide resin or the like. The intermediate transfer body 40 is stretched over a plurality of (six in the present example) tension rolls 41 (specifically, 41a to 41f). In the present example, among the plurality of tension rolls 41, for example, the tension roll 41a is used as a driving roll, and the other tension rolls 41b to 41f are used as driven rolls. In the present example, the photoconductors 31 of the image forming portions 30 are arranged at predetermined intervals to face a horizontal portion 40h of the intermediate transfer body 40, which is stretched between the tension rolls 41a and 41b.

On a back surface of the horizontal portion 40h of the intermediate transfer body 40, the primary transfer device 42 is provided to face the photoconductor 31 of each image forming portion 30. Each primary transfer device 42 electrostatically transfers the image formed by each image forming portion 30 to the intermediate transfer body 40. Here, the primary transfer device 42 may be selected as appropriate as long as the primary transfer device 42 causes a transfer electric field for attracting the image on the photoconductor 31 to the intermediate transfer body 40 side to act. For example, a transfer member (for example, a transfer roll, a discharge wire for generating a corona discharge, or the like) need only be installed to face the photoconductor 31, and a transfer voltage for primary transfer need only be applied to the transfer member.

Further, an intermediate transfer body cleaning device 45 is provided on an outer peripheral surface of the intermediate transfer body 40, which is stretched over the tension roll 41a. The intermediate transfer body cleaning device 45 cleans the residues such as the toner, paper dust, and the like remaining on the intermediate transfer body 40 after the image is transferred to the medium.

### Transfer Device

In the present example, the transfer device 50 is provided on an outer peripheral surface of the intermediate transfer body 40, which is stretched over the tension roll 41e. The transfer device 50 electrostatically transfers the image held on the intermediate transfer body 40 to the medium. Here, the transfer device 50 may be selected as appropriate as long as the transfer device 50 causes a transfer electric field for attracting the image on the intermediate transfer body to the medium side to act. For example, the transfer member 51 need only be installed to face the tension roll 41e of the intermediate transfer body 40, and a transfer voltage for secondary transfer need only be applied to the transfer member 51 or the tension roll 41e to form a transfer electric field for secondary (batch) transfer between the transfer member 51 and the tension roll 41e. In the present example, a transfer belt module 52 is adopted as the transfer member 51. The transfer belt module 52 has an aspect in which a transfer belt 52c is stretched between a transfer roll 52a and a peeling roll 52b. In the present example, a transfer electric field is formed between the transfer roll 52a and the tension roll 41e, and an action region of the transfer electric field acts as a transfer region TR. The medium S receives the image transfer operation in the transfer region TR, passes through the transfer region TR, is guided along the transfer belt 52c, and is peeled off by the peeling roll 52b.

The transfer member 51 is not limited to the transfer belt module 52, and an aspect in which only the transfer roll is used or a discharge wire using a corona discharge or the like may be selected as appropriate.

### Medium Transport System

In the present example, the medium transport system 23 includes a medium supply device 60 that supplies the medium S. In the present example, a sheet-like medium S cut to a predetermined size is used. This medium supply device 60 accommodates the medium S in an accommodation container 61 and sends out the medium S one by one by a feeder 62. In the present example, one accommodation container 61 is provided, but a plurality of accommodation containers 61 may be provided.

In addition, a vertical transport path 63 that transports the medium S supplied from the medium supply device 60 in a substantially vertical direction is provided in the unit housing 21. A horizontal transport path 64 that transports the medium S in a substantially horizontal direction is provided on an upper side of the vertical transport path 63. Here, the horizontal transport path 64 extends to a discharge port 21a open in a side wall of the unit housing 21. In addition, a medium discharge receiver (not shown) that receives the discharged medium S is provided outside the discharge port 21a of the unit housing 21. An appropriate number of transport rolls 65 (specifically, 65a to 65d) are provided in the vertical transport path 63 and the horizontal transport path 64. The transport roll 65d provided immediately before the discharge port 21a functions as a discharge roll that discharges the medium S to the discharge receiver.

Further, in the horizontal transport path 64, an alignment roll 66 is provided upstream of the transfer region TR of the transfer device 50 in the transport direction of the medium S. The alignment roll 66 aligns the leading end of the medium S supplied from the medium supply device 60 and then sends out the medium S toward the transfer region TR at an appropriate timing. Further, a guide member 67 that guides the medium S toward the transfer region TR is provided between the alignment roll 66 and the transfer region TR.

In addition, in the horizontal transport path 64, a transport belt 68 is provided downstream of the transfer device 50 in the transport direction of the medium S. The transport belt 68 transport the medium S on which the unfixed image is held, by stably holding the medium S in a state of being electrostatically attracted.

Further, in the horizontal transport path 64, the fixing device 24 is provided downstream of the transport belt 68 in the transport direction of the medium S. In the horizontal transport path 64, the post-processing device 25 is provided downstream of the fixing device 24 in the transport direction of the medium S.

In the present example, the medium transport system 23 has the aspect in which only the vertical transport path 63 and the horizontal transport path 64 are provided, but the present invention is not limited to this. For example, a reversible branch transport path (not shown) that branches downward between the fixing device 24 and the post-processing device 25 may be provided in the horizontal transport path 64. In the aspect in which the branch transport path is provided, the medium reversed by the branch transport path may be returned to the vertical transport path 63 again from the horizontal transport path 64 through a return transport path. In this case, it is possible to transfer the image to the back surface of the reversed medium in the transfer region TR. In addition, a branch return transport path that branches from the middle in the branch transport path may be provided, and the reversed medium may be discharged to the medium discharge receiver outside the unit housing 21.

### Fixing Device

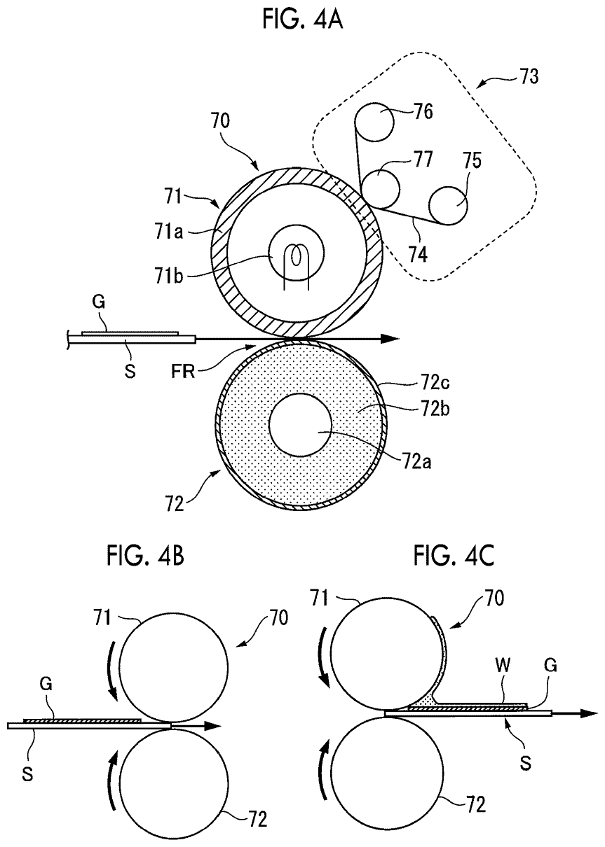

In the present example, as shown in FIG. 4A, the fixing device 24 performs heating and pressurization to fix the image on the medium S. The fixing device 24 includes a heating roll 71 as the fixing member for heating and a pressure roll 72 as the fixing member for pressurization. The heating roll 71 is disposed in contact with an image holding surface side of the medium S and rotates via a drive force from a drive source (not shown). On the other hand, the pressure roll 72 is disposed to face the heating roll 71 in a strongly pressed manner and rotates following the heating roll 71. Therefore, the fixing device 24 allows the image G formed using the toner held on the medium S to pass through a fixing region FR between the heating roll 71 and the pressure roll 72, and performs heating and pressurization to fix the image G.

In the present example, the heating roll 71 is formed in an aspect in which a heater 71b is built in a roll body 71a made of metal having a high thermal conductivity. Here, a heating method of the heating roll 71 is not limited to this, and the roll body 71a may be heated by bringing an external heater (not shown) into contact with an outer peripheral surface of the roll body 71a.

On the other hand, the pressure roll 72 is formed by laminating a heat-resistant elastic layer 72b around a core bar 72a made of metal, and coating a surface of the elastic layer 72b with a protective layer 72c. A heater may be added to the pressure roll 72 as necessary.

In the present example, the medium S is allowed to, in a state of being nipped by the elastic deformation of the pressure roll 72, pass through the fixing region FR between the heating roll 71 and the pressure roll 72 and the image G on the medium S is heated and pressurized.

In the present example, the fixing device 24 has a roll pair configuration, but the present invention is not limited to this, and the fixing device 24 may be selected as appropriate, for example, to be configured with a heating belt in which an electromagnetic induction heating method is adopted, instead of the heating roll 71.

### Cleaning Mechanism

In the present exemplary embodiment, the heating roll 71 of the fixing device 24 is provided with a cleaning mechanism 73. The cleaning mechanism 73 mostly reduces a wax component in the toner adhering to the heating roll 71.

Here, the reason why the wax component adheres to the heating roll 71 will be briefly supplemented.

In general, the toner used in the developing device 34 of the image forming portion 30 contains the wax. Therefore, as shown in FIG. 4A, the image G formed using the toner transferred to the medium S contains the wax component. In this state, as shown in FIGS. 4B and 4C, in a case where the medium S holding the image G passes through the fixing region FR of the fixing device 24, the image G is fixed on the medium S in the fixing region FR by performing heating and pressurization. In this case, a situation occurs in which a portion of the wax W on a toner surface is transferred from the image G portion to the heating roll 71 by the heating.

In the present example, as shown in FIG. 4A, the cleaning mechanism 73 adopts a method of pressing and moving the cleaning member in a rubbing manner on the surface of the heating roll 71. Specifically, the cleaning mechanism 73 includes a cleaning web 74, a delivery roll 75, a winding roll 76, and a pressing roll 77. Here, the cleaning web 74 is, for example, an example of a cleaning member consisting of a heat-resistant nonwoven fabric or the like. The delivery roll 75 is an example of a delivery member around which the cleaning web 74 is wound in a state of being braked to be delivered. The winding roll 76 is an example of a winding member around which the used part of the cleaning web 74 is wound to be wound. Further, the pressing roll 77 is an example of a pressing member that presses the cleaning web 74 stretched between the delivery roll 75 and the winding roll 76 against the heating roll 71.

With the cleaning mechanism 73 according to the present example, the cleaning web 74 is pressed and moved in a rubbing manner on the surface of the heating roll 71. In this case, since the cleaning web 74 is made of a heat-resistant nonwoven fabric or the like, the liquefied wax W is absorbed by the capillary phenomenon on the surface of the heating roll 71. In the present example, it is effective to gradually wind the cleaning web 74 in terms of increasing an absorption life of the cleaning web 74.

### Issue of Cleaning Mechanism

The cleaning mechanism 73 according to the present example has the following issue.

In the cleaning mechanism 73 according to the present example, the cleaning web 74 has a structure in which the cleaning web 74 comes into contact with the rotating heating roll 71 only once in principle. Therefore, there may be a case where the wax W cannot be sufficiently absorbed due to the capillary phenomenon in a case where the cleaning web 74 comes into contact with the wax W which is liquefied but still has viscosity only once.

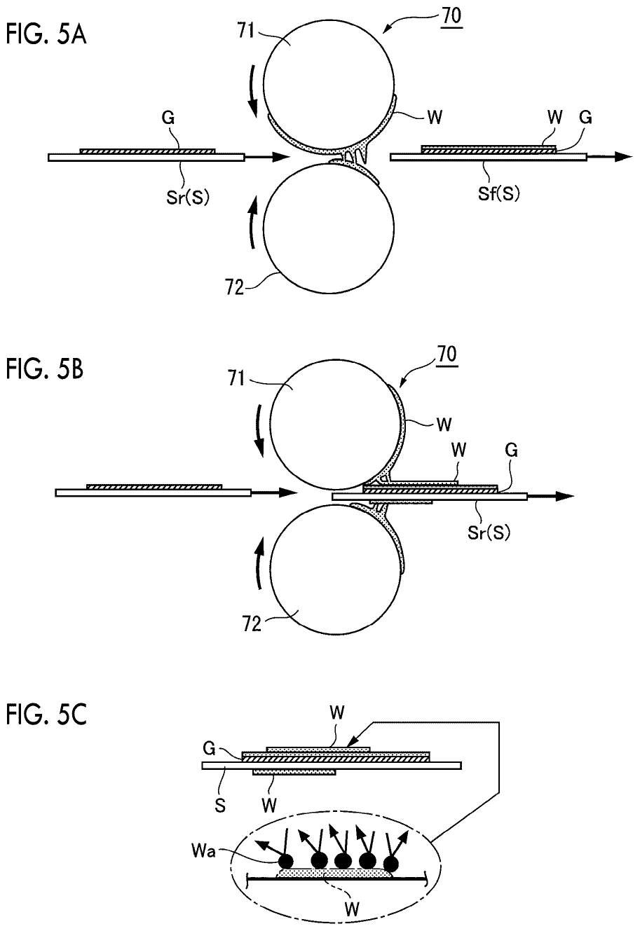

In this case, as shown in FIG. 5A, a situation before a preceding medium Sf exits the fixing region FR of the fixing device 24 and the subsequent medium Sr enters the fixing region FR of the fixing device 24 is assumed. In an inter-image region between the preceding medium Sf and the subsequent medium Sr (region between the media S), the heating roll 71 and the pressure roll 72 are in a state of being in direct contact with each other in the fixing region FR. In this state, a portion of the wax W transferred to the heating roll 71 is not cleaned by the cleaning mechanism 73 (see FIG. 4A) and slips. In this case, a situation may occur in which the wax W is transferred from the heating roll 71 to the pressure roll 72.

Thereafter, as shown in FIG. 5B, in a case where the subsequent medium Sr passes through the fixing region FR, a situation occurs in which the wax W transferred to the heating roll 71 and the pressure roll 72 is counter-transferred to the front surface and the back surface of the medium S.

Therefore, the wax W may remain on the surface of the medium S even after the fixation using the fixing device 24. In this case, as shown in FIG. 5C, the wax W remaining on the medium S is aggregated in a granular form and solidified along with the cooling of the medium S, and is changed to the granular mass Wa. In this state, for example, in a case where the medium S is a transparent film medium, a situation may occur in which the reflected light or the transmitted light to the medium S is scattered by the granular mass Wa, and the wax trace is visualized. In this way, in a case where the wax trace is visualized, the wax trace is manifested as a contamination or an image defect of the medium S.

In order to eliminate such a situation, for example, it is considered to increase the number of times of contact between the heating roll 71 and the cleaning web 74 of the cleaning mechanism 73. However, this measure requires the rotation of the heating roll 71 to be continued for a long time, and the fixing processing using the fixing device 24 is required to be waited for during the time, so that it cannot be said that this measure is a desired measure.

In the present example, although the cleaning mechanism 73 is provided only on the heating roll 71, it goes without saying that the cleaning mechanism 73 may be provided on the pressure roll 72 side, but even in a case where the cleaning mechanism 73 is added to both the heating roll 71 and the pressure roll 72, it is difficult to completely remove the wax W that slips through the cleaning mechanism 73 on the heating roll 71 and the pressure roll 72.

### Post-Processing Device

In the present exemplary embodiment, as shown in FIG. 3, the post-processing device 25 is provided downstream of the fixing device 24 in the transport direction of the medium S, in consideration of a possibility that the wax W remains on the medium S that has passed through the fixing device 24.

In the present example, the post-processing device 25 performs the post-processing of changing the wax remaining on the medium S from a visible state (granular mass) to a less visible state (smoothed state). This is to suppress a light scattering phenomenon caused by the granular mass Wa by spreading and smoothing the granular mass Wa via the rubbing operation.

### Basic Configuration of Post-Processing Device

In the present example, the post-processing device 25 includes a transport roll 80 as a transport section that transports the medium S at a transport speed v0, and a rubbing roll 90 as a rubbing section that is located downstream of the transport roll 80 in the transport direction of the medium S and that rubs the surface of the medium S in a direction identical to the transport direction of the medium S at the speed v1 higher than the transport speed v0, and the transport roll 80 and the rubbing roll 90 are appropriately arranged and mounted in a housing (not shown).

In the present example, the rubbing roll 90 is configured to rub both the front and back surfaces of the medium S, as in Exemplary Embodiment 1. In the housing (not shown), an inlet opening and an outlet opening for the medium S to pass through are formed.

In the present example, the rubbing roll 90 is configured to rub both the front and back surfaces of the medium S. This is because there is a possibility that the wax W is transferred to both the front and back surfaces of the medium S that has passed through the fixing device 24.

### Transport Roll

### Configuration Example and Drive Method of Transport Roll

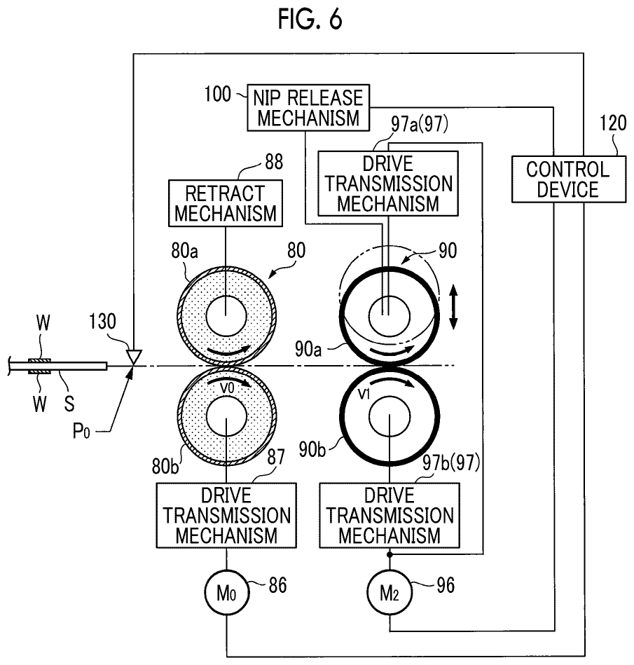

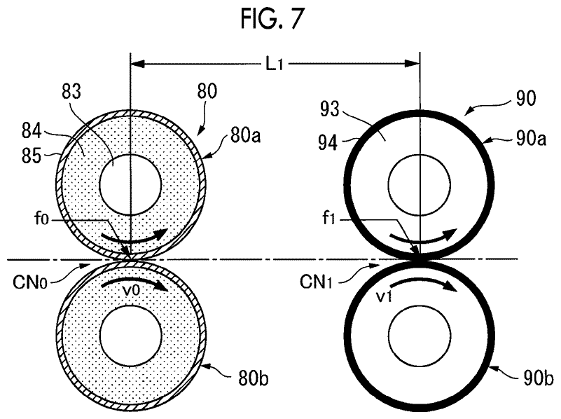

In the present example, as shown in FIGS. 6 and 7, the transport roll 80 consists of the plurality of rotating bodies 80a and 80b that are disposed to face each other with respect to the medium S. The rotating bodies 80a and 80b constituting the transport roll 80 have a structure in which a solid shaft 83 made of metal such as SUS is covered with an elastic layer 84 such as silicone rubber, and a mold-releasing layer 85 such as PFA for preventing the wax adhesion is provided on a surface of the elastic layer 84.

In the present example, as the method of driving the transport roll 80, the plurality of rotating bodies 80a and 80b are disposed in contact with each other, and the medium S is nipped in the contact region CN0 between the rotating bodies 80a and 80b and transported. Here, in the transport roll 80, among the plurality of rotating bodies 80a and 80b, for example, the rotating body 80b located on the lower side is a driving roll, and the rotating body 80a located on the upper side is a driven roll. Then, a drive force from a drive motor 86 is transmitted to the rotating body 80b as a driving roll via a drive transmission mechanism 87 such as a drive transmission gear train.

### Retract Configuration Example of Transport Roll

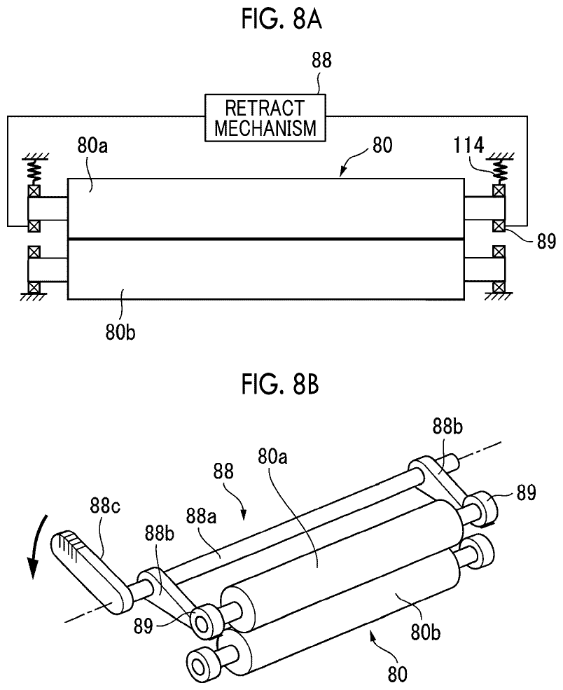

In the present example, as shown in FIGS. 6, 8A, and 8B, a retract mechanism 88 as a retractable retract section is provided in one rotating body 80a of the transport roll 80. The retract mechanism 88 supports both ends of the shaft 83 of one rotating body 80a, and releases a nip state (corresponding to a contact state between the plurality of rotating bodies 80a and 80b) of the transport roll 80, for example, in a case where the medium S is jammed. In the present example, as shown in FIG. 8B, the retract mechanism 88 has, on both sides of a support shaft 88a that is rotatable, support arms 88b that protrude radially with respect to the support shaft 88a. The support arms 88b support bearings 89 provided at both ends of the shaft 83 of one rotating body 80a from below. In addition, an operation lever 88c that protrudes radially with respect to the support shaft 88a in a direction different from the support arms 88b is provided at one end of the support shaft 88a.

### Setting of Nip Pressure of Transport Roll

As shown in FIG. 8A, biasing springs 114 as biasing sections for adjusting a nip pressure (corresponding to a contact pressure of the contact region CN0 between the plurality of rotating bodies 80a and 80b) of the transport roll 80 are provided at both ends of one rotating body 80a of the transport roll 80. The biasing spring 114 is composed of, for example, a compression coil spring, and can variably set a biasing force by adjusting the compression deformation amount via an adjustment portion (not shown). As a result, the nip pressure of the transport roll 80 is set.

### Use Example of Retract Mechanism

In the present example, the retract mechanism 88 need only be operated, for example, in a case where the medium S is jammed (medium jam) during the passage of the transport roll 80. Specifically, as shown in FIG. 8B, an operator need only manually push down the operation lever 88c of the retract mechanism 88 and swing the support arms 88b upward about the support shaft 88a. In this case, the rotating body 80a is pushed up by the support arms 88b against the biasing force of the biasing springs 114, and the contact state between the plurality of rotating bodies 80a and 80b is released. In a case where the operation lever 88c is returned to an original position, the contact state between the plurality of rotating bodies 80a and 80b is returned to an original state.

### Rubbing Roll

### Configuration Example of Rubbing Roll

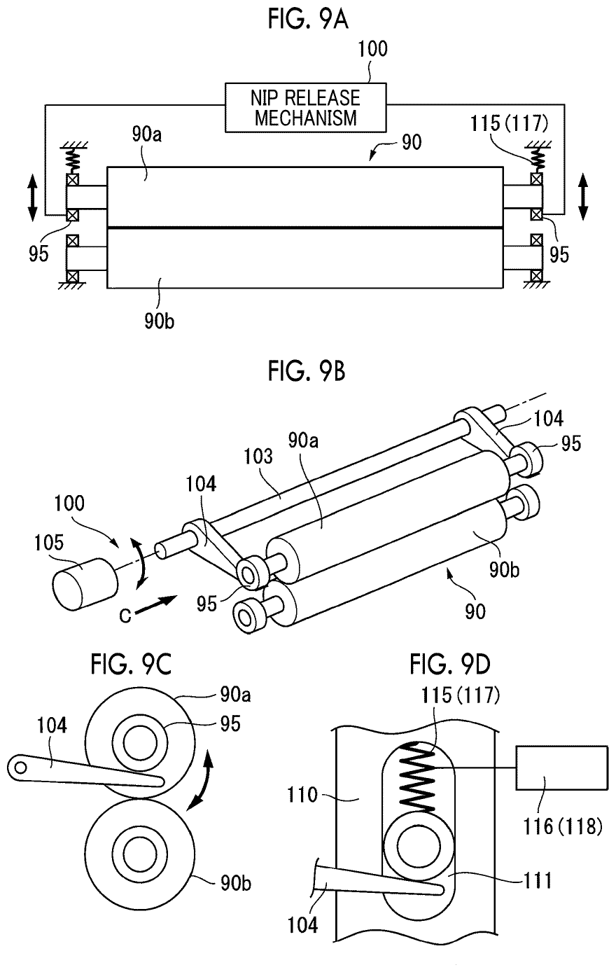

In the present example, as shown in FIGS. 7 and 9, the rubbing roll 90 consists of the plurality of rotating bodies 90a and 90b that are disposed to face each other with respect to the medium S. In the present example, the rotating bodies 90a and 90b constituting the rubbing roll 90 need only have, at least on a surface, a rubbing portion 94 for rubbing the wax W. In the present example, each of the rotating bodies 90a and 90b has, for example, a structure in which a surface of a roll body 93 including a solid shaft made of metal such as SUS is covered with the rubbing portion 94.

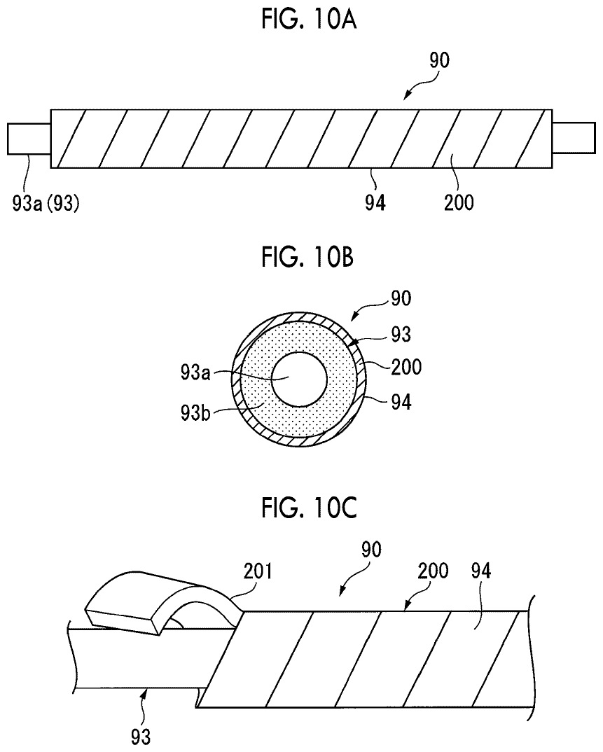

In the present example, as shown in FIGS. 10A and 10B, the roll body 93 is formed by laminating an elastic layer 93b such as silicone rubber around a metal shaft 93a.

In the present example, the roll body 93 has the elastic layer 93b, and thus the roll body 93 elastically biases the rubbing portion 94 against the medium S. Therefore, for example, this configuration is preferable in that the contact state between the medium S and the rubbing portion 94 is maintained in a good state even in a case where the member constituting the rubbing portion 94 is slightly worn due to the temporal change.

In addition, the rubbing portion 94 can be formed by using a member that performs the rubbing effect.

In the present example, the surface of the roll body 93 is wound and fixed with a cloth material 200 made of a fiber material such as a woven fabric or a knitted fabric. The rubbing portion 94 described above is formed by using a surface portion of the cloth material 200.

Further, in the present example, examples of the method of manufacturing the rubbing roll 90 include the method shown in FIG. 10C.

In the same drawing, in order to manufacture the rubbing roll 90, for example, a belt-shaped member 201 in which the cloth material 200 is formed in a band shape may be prepared, and the belt-shaped member 201 may be spirally wound around the roll body 93 and fixed with an adhesive (not shown).

In addition, the details of the rubbing portion 94 of the rubbing roll 90 will be described later.

### Drive Method of Rubbing Roll

In addition, in the present example, the rubbing roll 90 uses both the rotating bodies 90a and 90b as driving rolls. That is, a drive force from a drive motor 96 is transmitted to both the rotating bodies 90a and 90b via drive transmission mechanisms 97 (specifically, 97a and 97b) such as drive transmission gear trains. Here, the drive transmission mechanisms 97a and 97b may be partially shared or may be separately provided.

### Speed Condition of Rubbing Roll

As shown in FIGS. 6 and 7, the rubbing roll 90 need only rub the surface of the medium S in the same direction as the transport direction of the medium S at the speed v1 that is higher than the transport speed v0 of the transport roll 80.

In the present example, the rubbing roll 90 is selected to rotate in the same direction as the transport direction of the medium S in a contact region CN1 between the plurality of rotating bodies 90a and 90b. That is, the rotating body 90a located on the upper side rotates in a counterclockwise direction, and the rotating body 90b located on the lower side rotates in a clockwise direction.

In a case of such a selection, a speed difference (v1−v0) between the rubbing roll 90 and the transport roll 80 is greater than zero. Therefore, the medium S is transported by the transport roll 80 at the transport speed v0. In this situation, in a case where the medium S passes through the rubbing roll 90, the rubbing operation using the rubbing roll 90 on the surface of the medium S is ensured.

Here, the speed v1 of the rubbing roll 90 may be selected as appropriate. However, in order to increase the rubbing resistance of the rubbing roll 90, for example, it is preferable to set v1 to be high. In the present example, the value is set to about 5 to 10 times v0 in the absolute value.

### Contact/Separation Configuration Example of Rubbing Roll

In the present example, as shown in FIGS. 6, 9A, and 9B, one rotating body 90a of the rubbing roll 90 is provided with a nip release mechanism 100 as a contact/separation section that is movable between a contact position at which the rotating body 90a is in contact with the other rotating body 90b and a non-contact position at which the rotating body 90a is separated from the contact position. The nip release mechanism 100 supports both ends of the roll body 93 of the rotating body 90a, and switches between the nip state of the rubbing roll 90 (corresponding to the contact state between the plurality of rotating bodies 90a and 90b) and a release state (corresponding to a non-contact state between the plurality of rotating bodies 90a and 90b) based on a control signal. In the present example, as shown in FIG. 9B, the nip release mechanism 100 has, on both sides of a support shaft 103 that is rotatable, support arms 104 that protrude radially with respect to the support shaft 103.

The support arms 104 support the bearings 95 provided at both ends of the roll body 93 of one rotating body 90a, which is located on the upper side, from the lower side.

In the present example, the bearings 95 provided at both ends of the roll body 93 are supported by a support panel 110 to be movable up and down. Specifically, an elongated hole 111 extending in an up-down direction is formed in the support panel 110. The elongated hole 111 is held such that the bearing 95 provided at each of both ends of the roll body 93 of the rotating body 90a can slide.

Further, a nip release motor 105 capable of forward and backward rotation is provided at one end of the support shaft 103 directly or via a drive transmission gear train (not shown). As shown in FIGS. 9B and 9C, the nip release motor 105 rotates the support shaft 103 forward and backward and swings the support arms 104 in a predetermined angle range.

### Setting of Nip Pressure of Rubbing Roll

In the present example, as shown in FIGS. 9A and 9D, the biasing spring 115 as a biasing section for adjusting a nip pressure of the rubbing roll 90 is provided in the rubbing roll 90. The nip pressure referred to here corresponds to the contact pressure in the contact region between the plurality of rotating bodies 90a and 90b. The biasing spring 115 is configured by, for example, a compression coil spring, and is interposed between, for example, an upper edge portion of the elongated hole 111 and the bearing 95 of the rotating body 90a. In addition, an adjustment portion 116 that adjusts the compression deformation amount is provided in the biasing spring 115. The adjustment portion 116 variably sets a biasing force of the biasing spring 115 by adjusting the compression deformation amount. As a result, the nip pressure of the rubbing roll 90 is set.

### Adjustment of Frictional Force of Rubbing Roll

In the present example, the rubbing roll 90 and the transport roll 80 come into contact with the medium S that moves. In this case, in a case where the medium S passes through the contact region CN1 of the rubbing roll 90, as shown in FIG. 7, the frictional force f1 is generated between the rubbing roll 90 and the medium S. Meanwhile, in a case where the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be greater than the frictional force f1 between the plurality of rotating bodies 90a and 90b constituting the rubbing roll 90 and the medium S.

Here, in a case where a normal force acting on the contact region CN0 of the transport roll 80 is denoted by U0, a kinetic friction coefficient between the transport roll 80 and the medium S is denoted by μ0, a normal force acting on the contact region CN1 of the rubbing roll 90 is denoted by U1, and a kinetic friction coefficient between the rubbing roll 90 and the medium S is denoted by μ1, the relationship is represented as follows.

f0=μ0·U0

f1=μl·U1

In order to satisfy the condition of f0>f1, since the kinetic friction coefficients μ0 and μ1 are values dependent on the materials and the like, the biasing forces of the biasing springs 114 and 115 that affect the normal forces U0 and U1 need only be adjusted in consideration of the respective kinetic friction coefficients. Here, since U0 is selected such that the transportability of the medium S is ensured at an appropriate level, for example, it is preferable to mostly adjust the biasing force of the biasing spring 115 and appropriately adjust the frictional force f1.

### Rubbing Portion of Rubbing Roll

### Material Forming Rubbing Portion

In the present example, as the material forming the rubbing portion 94, for example, a fiber material such as a woven fabric or a knitted fabric is used. For example, in a case where the rubbing portion is formed by using a nonwoven fabric such as felt or a raised pile fabric, there is a concern that rubbing unevenness or hair pulling occurs due to the rubbing roll. In this regard, in the present example, the above-described fiber material is selected as a material that is unlikely to cause rubbing unevenness or hair pulling by the rubbing roll 90.

Therefore, in the present example, the following materials are described as the cloth material 200 forming the rubbing portion 94.
(1) A woven fabric woven by combining yarns each consisting of warp and weft fibers.
(2) A knitted fabric that is formed with loops of yarns consisting of fibers being linked together to form a continuous mesh.

The number of fibers constituting the yarn may be one or a plurality.

### Configuration Example 1 of Rubbing Portion

The rubbing portion 94 of the present example has a woven fabric structure 210.

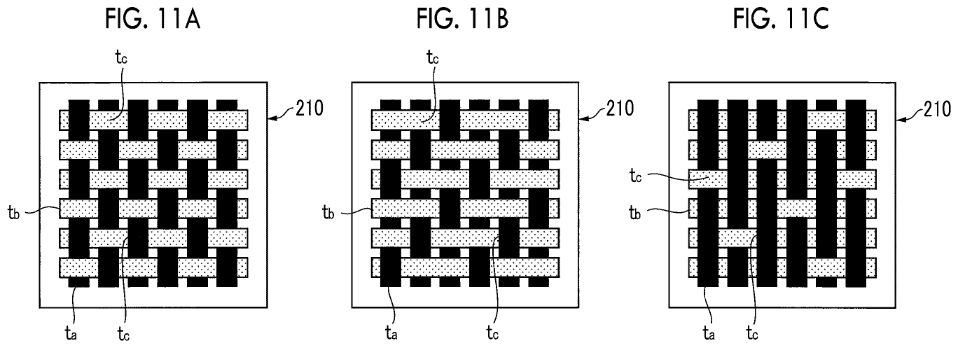

In the present example, the “woven fabric” is woven in various weaving methods by arranging warp yarns ta and weft yarns tb in two directions as shown in FIGS. 11A to 11C.

The weaving method is not limited, and plain weave, twill weave, satin weave, and the like may be used.

FIG. 11A shows the woven fabric structure 210 of the plain weave, which is made by alternately intersecting one warp yarn ta and one weft yarn tb. In the plain weave, there are many points tc at which the yarns intersect each other, the structure is strong and durable against friction. As a variation of the plain weave, one warp yarn and one weft yarn intersect each other in a normal structure, but there is an aspect in which two or more yarns are bundled together as a single yarn and woven.

FIG. 11B shows the woven fabric structure 210 of the twill weave, which is made by intersecting two warp yarns ta and two weft yarns tb with each other by skipping the two warp yarns ta and the two weft yarns tb. The twill weave has a structure in which the warp yarns ta are longer than the warp yarns and are likely to appear on the surface, as compared with the plain weave. In addition, since the number of points at which the yarns intersect each other is small, a plurality of adjacent yarns tend to approach each other, and a woven fabric structure with a small gap is likely to be formed. Therefore, it is possible to weave the yarns at a high density. In addition, in a case where a state where the warp yarns ta intersect the weft yarns tb in a “two up: two down” manner is called “2/2 twill weave”, the variations of the twill weave are as follows. For example, a state of intersection between the warp yarns ta and the weft yarns tb in a “two up: one down” manner is called “2/1 twill weave”, and a state of intersection between the warp yarns ta and the weft yarns tb in a “three up: one down” manner is called “3/1 twill weave”, and similarly, there are “3/3 twill weave”, “3/2 twill weave”, and the like.

FIG. 11C shows the woven fabric structure 210 of the satin weave, in which the warp yarns ta or the weft yarns tb skips i yarns (i=4 in the present example), pass underneath, and intersect each other. For example, in a case of i=4, the warp yarn ta and the weft yarn tb intersect with each other in a manner of “four up: one down” (referred to as five-harness satin weave), but the present configuration is not limited thereto. As compared with other weaving methods, the number of points at which the yarns intersect each other is small, and the structure is such that either the warp yarn ta or the weft yarn tb hardly appears on the surface. Since this structure is smooth and easy to slide compared with other weaving methods, it is necessary to pay attention in a case where this structure is adopted as the rubbing portion 94.

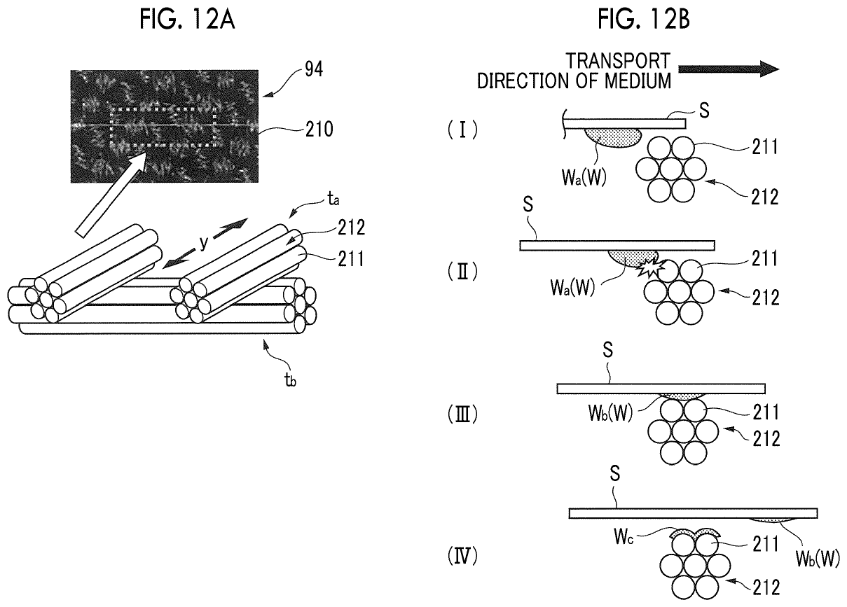

FIG. 12A is a schematic diagram showing a case where the woven fabric is used as the cloth material 200 and the woven fabric structure 210 is used as the rubbing portion 94.

In the same drawing, the rubbing portion 94 is disposed such that the warp yarn ta and the weft yarn tb intersect with each other.

In the present example, both the warp yarns ta and the weft yarns tb are formed as a fiber bundle 212 in which a plurality of fibers 211 are bundled. A type of the fibers 211 used in the present example may be selected as appropriate, and, for example, microfiber having a fiber diameter of less than 10 μm is preferable. Here, a material of the fibers 211 is mostly polyester, composite fibers of polyester and nylon, and the like, but also widely includes other materials.

In particular, in the present example, a disposition relationship of the fibers 211 constituting the rubbing portion 94 is a major factor in order to ensure a rubbing operation effect of the rubbing roll 90. In the present example, any one of the warp yarn ta or the weft yarn tb (the warp yarn ta in the present example) is disposed in the direction intersecting the transport direction of the medium S, and the other (the weft yarn tb in the present example) is disposed in the direction along the transport direction of the medium S. In particular, in the present example, a width direction y orthogonal to the transport direction of the medium S is selected as a representative example of the “direction intersecting the transport direction of the medium S”. Therefore, in the present example, the warp yarns ta are arranged in a regular pattern in the width direction y of the medium S.

### Rubbing Operation Effect According to Configuration Example 1 of Rubbing Portion

FIG. 12B is a diagram showing a rubbing operation effect of the rubbing portion 94 in the present example.

It is assumed that the wax W, in a form of a granular mass Wa, is held on the medium S that has passed through the fixing device 24.

The medium S moves toward the post-processing device 25, and as shown in (I) of FIG. 12B, the wax W on the medium S reaches the position of the rubbing portion 94 of the rubbing roll 90.

Then, as shown in (II) of FIG. 12B, the wax W on the medium S collides with the warp yarn ta (fiber bundle 212 extending in the width direction of the medium S) of the rubbing portion 94. Specifically, the wax W on the medium S collides with the fibers 211 that are close to the medium S in the fiber bundle 212 including the warp yarn ta.

In the present example, two fibers 211 close to the medium S are arranged in the fiber bundle 212. Therefore, the surface of the wax W held on the medium S is rubbed by the two fibers 211, and the wax W is thinned (see (III) of FIG. 12B).

Then, in a case where the wax W on the medium S passes through the rubbing portion 94 of the rubbing roll 90, the wax W changes from the granular mass Wa to the thin film-like layer Wb. On the other hand, a portion Wc of the wax W on the medium S is spread by the two contacted fibers 211 and adheres to the fibers 211 to be deposited (see (IV) of FIG. 12B).

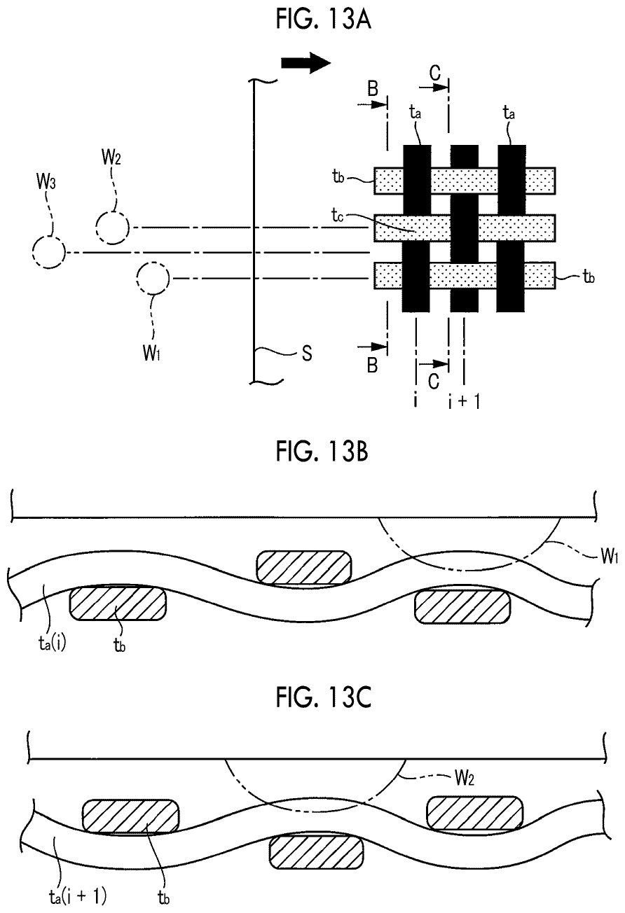

In the present example, since the rubbing portion 94 has the woven fabric structure 210 (for example, plain weave), there is the point tc at which the warp yarn ta and the weft yarn tb intersect each other (see FIGS. 13A and 13B). Therefore, the warp yarn ta extends, for example, in the width direction of the medium S, but the weft yarn tb is disposed on the warp yarn ta at the point tc at which the warp yarn ta intersects the weft yarn tb.

Now, as shown in FIGS. 13A and 13B, it is assumed that the warp yarn ta in the i-th row is disposed on the weft yarn tb and is located at a position through which the wax W1 on the medium S passes.

In this case, the wax W1 on the medium S collides with the warp yarn ta in the i-th row, and thus, as described above, the wax W1 on the medium S is rubbed and spread by the warp yarn ta.

On the other hand, as shown in FIGS. 13A and 13C, it is assumed that the warp yarn ta in the i-th row is disposed below the weft yarn tb and is located at a position through which wax W2 on the medium S passes.

In this case, the wax W2 on the medium S may not collide with the warp yarns Ta in the i-th row. However, since the warp yarn ta in the (i+1)th row is present at the position through which the wax W2 on the medium S passes, the wax W2 on the medium S collides with the warp yarn ta in the (i+1)th row (see FIGS. 13A and 13C). Therefore, as described above, the wax W2 on the medium S is rubbed and spread by the warp yarns ta.

In addition, as shown in FIG. 13A, it is assumed that the warp yarn ta in the i-th row is straddled by the portion above the weft yarn tb and the portion below the weft yarn tb at the position through which wax W3 on the medium S passes.

In this case, as shown in FIGS. 13A to 13C, a portion of the wax W3 on the medium S collides with the warp yarn ta in the i-th row, and the remaining portion of the wax W3 collides with the warp yarn ta in the (i+1)th row. Therefore, as described above, the wax W3 on the medium S is rubbed and spread by the two adjacent warp yarns ta.

### Configuration Example 2 of Rubbing Portion

The rubbing portion 94 of the present example has a knitted fabric structure 220.

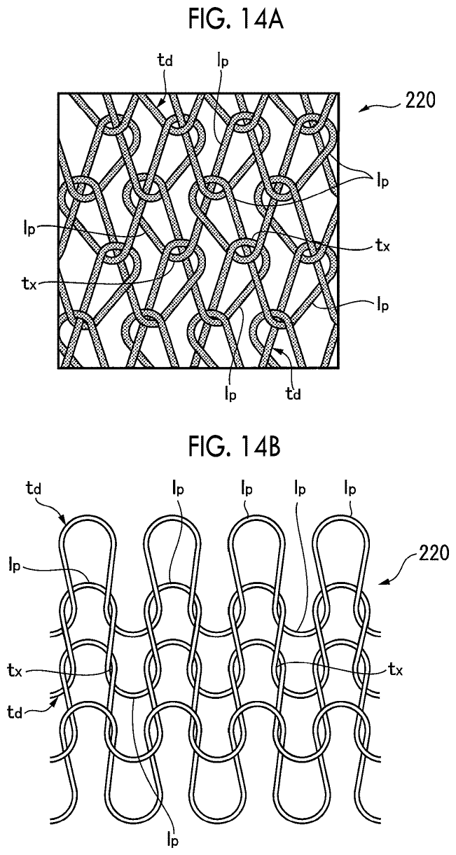

In the present example, the “knitted fabric” has a knitting method in which a process of making a loop 1p from one yarn td and making a new loop 1p to be entangled with the loop 1p is repeated to form chain stitches tx, as shown in FIGS. 14A and 14B.

The knitting method may be warp knitting, weft knitting, circular knitting, or the like.

FIG. 14A shows the knitted fabric structure 220 of the warp knitting, and the loops 1p are connected in the vertical direction. In the warp knitting, a large amount of yarns td are prepared, and the yarns td arranged in a large amount are knitted down.

FIG. 14B shows the knitted fabric structure 220 of the weft knitting, and the knitting method is a method of connecting the loops 1p in the horizontal direction. In the weft knitting, one yarn td reciprocates to the left and right, and the yarns are stacked one by one after the yarns reach the right end from the left end.

In the weft knitting, the knitted fabric in which the left end and the right end are stuck to each other to be in a “round” state is circular knitting.

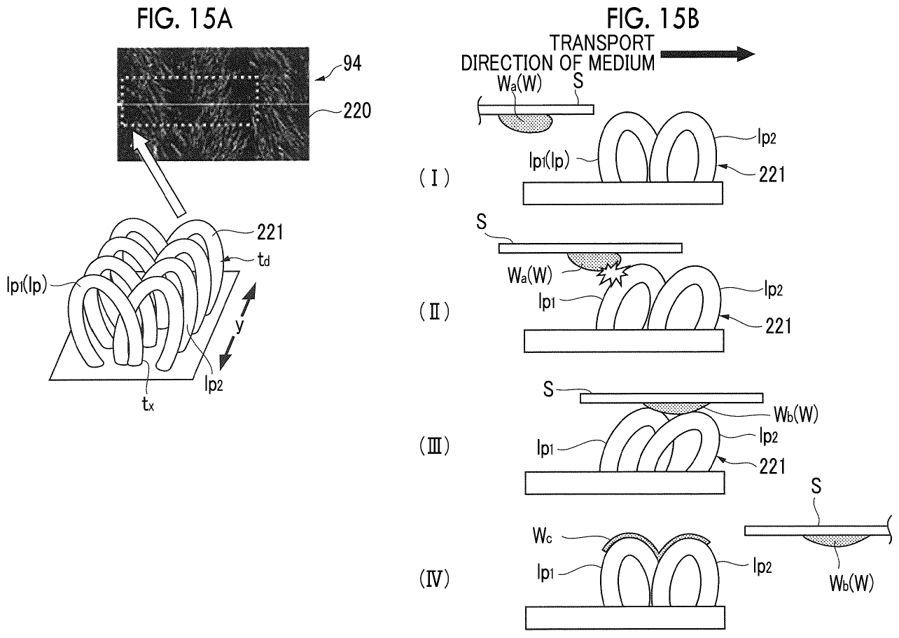

FIG. 15A is a schematic diagram showing a case where the knitted fabric is used as the cloth material 200 and the knitted fabric structure 220 is used as the rubbing portion 94.

In the same drawing, the rubbing portion 94 connects the loops 1p of the yarn tg each other to form the chain stitches tx. In the present example, the yarn td is formed by one or a plurality of fibers 221. A type of the fibers 221 used in the present example may be selected as appropriate, and, for example, microfiber having a fiber diameter of less than 10 μm is preferable. Here, a material of the fiber may be selected as appropriate. In the present example, polyester, composite fibers of polyester and nylon, and the like are used as in Configuration Example 1 of the rubbing portion 94.

In particular, in the present example, a disposition relationship of the loops 1p constituting the rubbing portion 94 is major factor in order to ensure the rubbing operation effect of the rubbing roll 90. In the present example, the adjacent loops 1p are disposed in the direction intersecting the transport direction of the medium S. In particular, in the present example, the width direction orthogonal to the transport direction of the medium S is selected as a representative example of the “direction intersecting the transport direction of the medium S”.

In addition, in the present example, since a plurality of loops 1p are intertwined in the chain stitches tx, the adjacent loops 1p are regularly and closely arranged in two rows along the width direction orthogonal to the transport direction of the medium S.

### Rubbing Operation Effect According to Configuration Example 2 of Rubbing Portion

FIG. 15B is a diagram showing a rubbing operation effect of the rubbing portion 94 in the present example.

It is assumed that the wax W, in a form of the granular mass Wa, is held on the medium S that has passed through the fixing device 24.

The medium S moves toward the post-processing device 25, and as shown in (I) of FIG. 15B, the wax W on the medium S reaches the position of the rubbing portion 94 of the rubbing roll 90.

Then, as shown in (II) of FIG. 15B, the wax W on the medium S collides with the protruding end portions of the loops 1p1 in the first row facing the transport direction of the medium S among the loops 1p (specifically, 1p1 and 1p2) of the rubbing portion 94.

In the present example, the loops 1p of the rubbing portion 94 are arranged in two rows. Therefore, the surface of the wax W held on the medium S is rubbed by the loops 1p (1p1 and 1p2) arranged in two rows, and the wax Wis thinned (see (III) of FIG. 15B).

Then, in a case where the wax W on the medium S passes through the rubbing portion 94 of the rubbing roll 90, the wax W changes from the granular mass Wa to the thin film-like layer Wb. On the other hand, the portion Wc of the wax W on the medium S is spread on the loops 1p (1p1 and 1p2) configured in two rows in contact with the medium S, and adheres to the loops 1p to be deposited (see (IV) of FIG. 15B).

### Shape and Fiber Diameter of Fiber Material

The shape of the fiber material is largely classified into, for example, a sea-island type microfiber 230, a split type microfiber 233, and a non-microfiber 236.

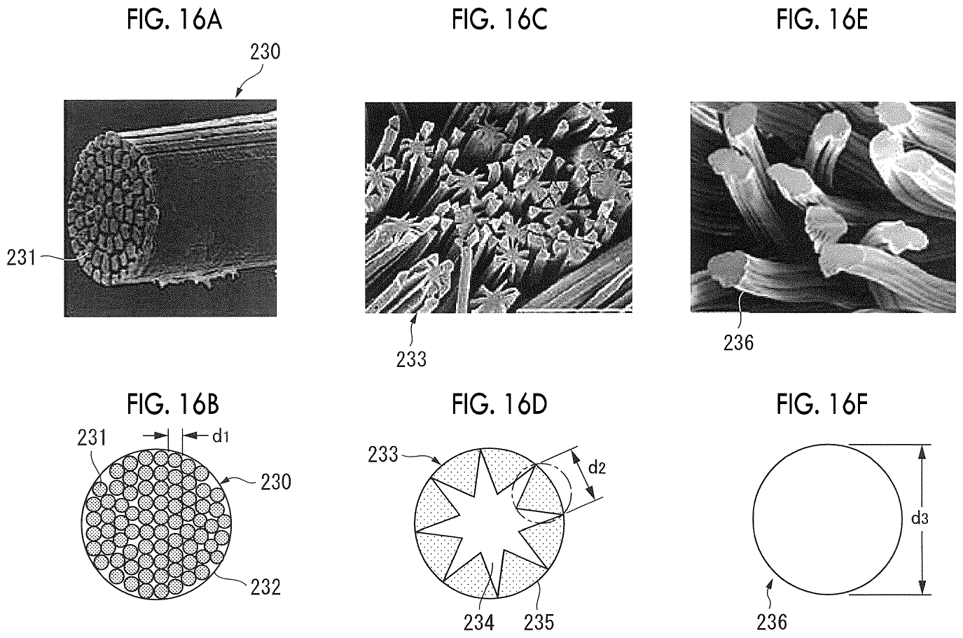

Here, as shown in FIGS. 16A and 16B, in the sea-island type microfiber 230, two polymer components that are thermodynamically immiscible are used, one component is used as a dispersed phase (island component), the other component as a continuous phase (sea component), and the microfibers that are island components 231 are collected in the sea component 232 at a predetermined ratio. In this case, a fiber diameter d1 of the microfiber that is the island component 231 is configured to be 2 to 3 μm. In the sea-island type microfiber 230 obtained by combining these microfibers, the microfibers of the island components 231 are bundled in a region of the sea component 232. Therefore, the fiber diameter of the sea-island type microfiber 230 is obtained as a value that substantially corresponds to the region of the sea component 232.

In addition, as shown in FIGS. 16C and 16D, in the split type microfiber 233, for example, a composite yarn is formed by using nylon for a central star-shaped portion 234 and polyester for a wedge-shaped portion 235 around the central star-shaped portion 234 and the composite yarn is chemically treated to divide and open the composite yarn. In the present example, the wedge-shaped portion 235 is formed as a microfiber having a fiber diameter d2 (for example, 5 μm).

Further, FIGS. 16E and 16F show the non-microfibers 236 having a fiber diameter d3 of equal to or greater than 10 μm.

### Relationship Between Fiber Diameter of Fiber Material and Rubbing Operation on Wax

In a case where the rubbing portion 94 has the rubbing operation effect on the wax W on the medium S, the fiber diameter d of the fibers constituting the rubbing portion 94 may be selected as appropriate.

Here, as an example, a case will be described in which the rubbing portion 94 is the woven fabric structure 210, and a range of the fiber diameter of the fibers 211 constituting the rubbing portion 94 will be examined.

Here, the fiber diameter of the fibers 211 constituting the rubbing portion 94 is denoted by d, the height of the wax W before the post-processing is denoted by h, and the length of the wax W before the post-processing in the transport direction of the medium S is denoted by m.

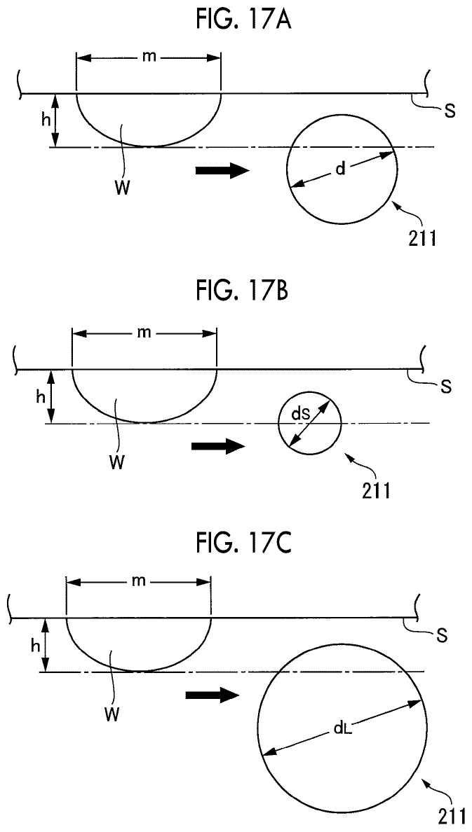

FIG. 17A shows a case where the fiber diameter d of the fibers 211 constituting the rubbing portion 94 is appropriate.

The Present Example Shows a Case where d>h and d<m.

In the present example, the fibers 211 constituting the rubbing portion 94 have the fiber diameter d smaller than the wax length m. Therefore, even in a case where the fibers 211 collide with the surface portion of the wax W, the contact area between the fibers 211 and the wax W increases, and the rubbing operation using the fibers 211 is stably performed. In addition, the fibers 211 constituting the rubbing portion 94 has the fiber diameter d larger than the wax height h. Therefore, even in a case where the fibers 211 collide with the surface portion of the wax W, there is no concern that the wax W rides on the fibers 211, and the rubbing operation using the fibers 211 is stably performed.

FIG. 17B shows an example of a case where the fiber diameter d of the fibers 211 constituting the rubbing portion 94 is inappropriate.

The present example shows a case where d=dS<h and dS<m. Here, dS indicates a fiber diameter smaller than the wax height h.

In the present example, the fibers 211 constituting the rubbing portion 94 have a fiber diameter dS smaller than the wax height h. Therefore, even in a case where the fibers 211 collide with the surface portion of the wax W, there is a concern that the wax W pushed by the fibers 211 rides on the fibers 211 having a small diameter. Therefore, after the wax W on the medium S has passed through the fibers 211, a portion of the wax W that rides on the fibers 211 returns to the medium S side again. Therefore, there is a concern that the rubbing operation on the wax W using the rubbing portion 211 is unstably performed.

FIG. 17C shows another example of a case where the fiber diameter d of the fibers 211 constituting the rubbing portion 94 is inappropriate.

The present example shows a case where d=dL>h and dL>m. Here, dL indicates a fiber diameter larger than the wax length m.

In the present example, the fibers 211 constituting the rubbing portion 94 has a fiber diameter dL larger than the wax length m. Therefore, even in a case where the fibers 211 collide with the surface portion of the wax W, the number of substantial contact surfaces of the fibers 211 having a large diameter with the wax Wis small, and thus the rubbing operation using the fibers 211 is likely to be unstable.

### Control System of Post-Processing Device

In the present exemplary embodiment, as shown in FIG. 6, a control device 120 that controls the respective elements (imaging engine 22, medium transport system 23, fixing device 24, post-processing device 25, and the like) of the image forming system 20 is provided.

The control device 120 is configured by a microcomputer including various processors.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

In the present example, in the horizontal transport path 64, a position sensor 130 as a position detection section is provided upstream of the post-processing device 25 in the transport direction of the medium S. Here, the position sensor 130 may be selected as appropriate as long as the position sensor 130 detects a timing at which a leading end part of the medium S passes through. Specific examples of the position sensor 130 include a mechanical switch such as a limit switch and an optical sensor having a light emitting unit and a light receiving unit.

In the present example, the control device 120 is a device in which required programs, such as the imaging program of the image forming system 20 and a control processing program of the post-processing device 25, are installed in advance in a memory (not shown). The control device 120 executes the imaging program by turning on a start switch (not shown), and sends out a control signal required for imaging processing to the imaging engine 22, the medium transport system 23, and the fixing device 24.

Further, it is assumed that the leading end part of the medium S, which has passed through the fixing device 24, passes through the position sensor 130. In this case, the control device 120 imports detection information from the position sensor 130 into the processor, and executes the control processing program of the post-processing device 25. Then, the control device 120 sends out a control signal for nip release to the nip release mechanism 100. Further, the control device 120 sends out a control signal for driving to each of the drive motors 86 and 96 of the transport roll 80 and the rubbing roll 90.

### Operation of Post-Processing Device

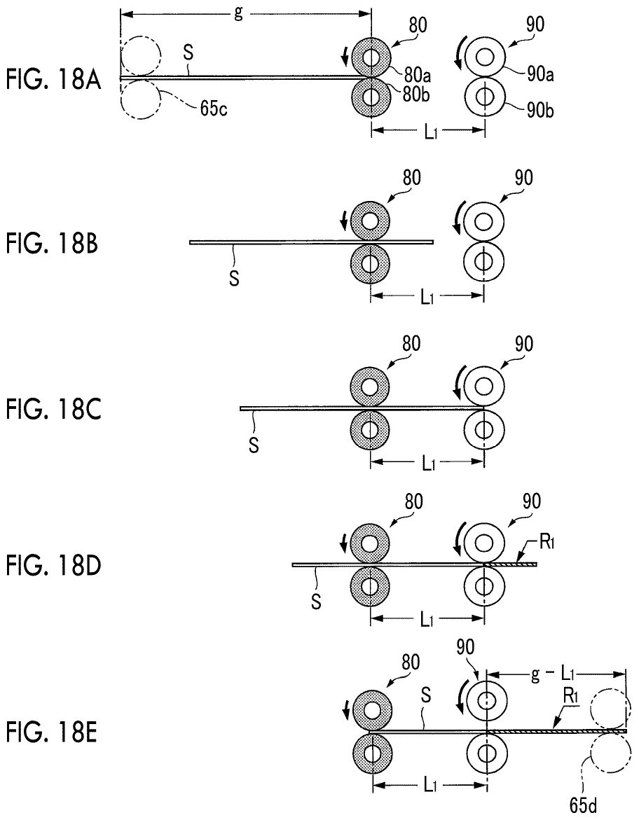

In the present example, the control device 120 executes control processing of the post-processing device 25, as shown in FIGS. 18A to 18E.

In the same drawing, a distance between the rubbing roll 90 and the transport roll 80 is denoted by L1, and the transport direction length of the medium S is denoted by g.

FIG. 18A shows a state where the leading end part of the medium S enters the transport roll 80. In this case, the medium S is transported by the transport roll 65c for feeding located on the inlet side of the post-processing device 25 and enters the transport roll 80.

FIG. 18B shows a state after the leading end part of the medium S has entered the transport roll 80. In this case, the transport roll 80 transports the medium S at the transport speed v0 to be directed to the rubbing roll 90. In this case, the rubbing roll 90 is disposed at the nip position and is in a standby state where the driving is started.

FIG. 18C shows a state where the leading end part of the medium S has entered the rubbing roll 90. In this case, the medium S is transported in a state of being pulled in the transport direction between the rubbing roll 90 and the transport roll 80. Therefore, the rubbing operation using the rubbing roll 90 is started from the leading end part of the medium.

FIG. 18D shows a state where the leading end part of the medium S passes through the rubbing roll 90. In this case, the rubbing operation using the rubbing roll 90 is carried out from the leading end part of the medium S toward the downstream side of the medium S in the transport direction. In FIG. 18D, R1 indicates a rubbing region (corresponding to a hatched region in the diagonally lower right in the drawing) of the rubbing roll 90 with respect to the medium S.

FIG. 18E shows a state immediately before the trailing end part of the medium S passes through the transport roll 80. In this case, the rubbing roll 90 is disposed at the release position, and the driving is stopped. During this period, the rubbing operation using the rubbing roll 90 is carried out from the leading end part of the medium S to the middle of the medium S in the transport direction. The rubbing operation using the rubbing roll 90 is stopped at a stage in which the rubbing roll 90 is disposed at the release position. In FIG. 18E, the rubbing region R1 of the rubbing roll 90 is provided substantially within a g-L1 range.

In addition, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R1 of the rubbing roll 90.

Form Change in Wax on Medium before and after Post-Processing

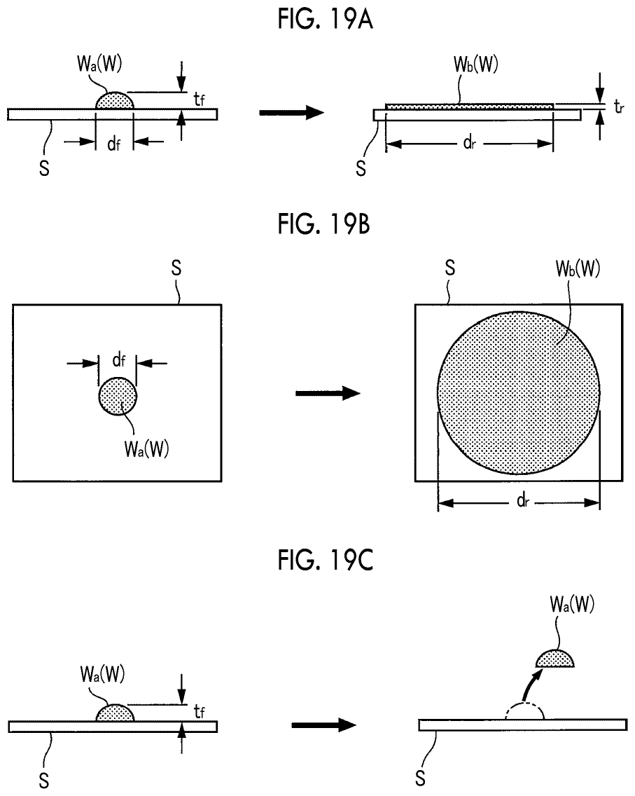

FIG. 19A shows a form change in the wax W before and after the post-processing using the post-processing device 25 in a case where the film medium having the smooth surface is used as the medium S.

In the same drawing, it can be seen that the wax W of the medium S before the post-processing passes through the fixing region FR and then is cooled and solidified to be the granular mass Wa (granular mass having a diameter df of, for example, 5 μm and a thickness tf of, for example, 0.3 μm).

However, after the post-processing using the post-processing device 25, the wax W consisting of the granular mass Wa before the post-processing is hardly visible. The granular mass Wa before the post-processing is spread in a flattened manner by the rubbing operation using the rubbing roll 90. As a result, it is confirmed that the form of the wax W is changed from the granular mass Wa to the thin film-like layer Wb.

In the present example, the wax W consisting of the thin film-like layer Wb is changed to have a smaller thickness tr and a larger diameter dr than the granular mass Wa.

In the present example, as shown in FIG. 19A and FIG. 19B, in the thin film-like layer Wb, the thickness tr is changed to be about ⅓ of the thickness tf (for example, 0.3 μm) before the processing, and the diameter dr is widely spread to be about 5 to 6 times the diameter df (for example, 5 μm) before the processing.

In this state, it is confirmed that the wax W consisting of the thin film-like layer Wb does not have the light scattering phenomenon, and the present of the wax W on the medium S cannot be visually confirmed.

In particular, in the present exemplary embodiment, the configuration of the rubbing portion 94 of the rubbing roll 90 is devised, so that the rubbing operation effect of the rubbing roll 90 is uniform, and no problems such as hair pulling, which occurs in a case where felt or pile fabric is used as the cloth material from the rubbing portion 94, are observed.

Condition that Makes Wax Less Visible

Here, regarding the form of the wax W after the post-processing using the post-processing device 25, it is presumed that the granular mass Wa is spread into the thin film-like layer Wb to be in a less visible state.

In this case, in a case where a relationship between the thickness tr of the thin film-like layer Wb and a condition that makes the wax less visible is examined, it is confirmed that, for example, it is preferable that the following relationship is satisfied.

tr≤0.15 μm

A method of measuring the thickness of the wax W and an analysis of a measurement result will be described in detail in Examples described later.

### Comparative Example 1

As shown in FIG. 19C, the post-processing device according to the present comparative example removes the wax W consisting of the granular mass Wa transferred to the medium S with a removal member such as a blade, in substantially the same manner as in JP2003-98917A (Detailed Description of the Invention, FIG. 1) or JP1995-89257B (Alias: JP H7-89257B) (Examples, FIG. 1).

In the present example, in a case where the wax W transferred to the medium S is to be mechanically completely removed, it is necessary to strongly press the removal member against the surface of the medium S. In this case, the image held on the medium S may be damaged, and it cannot be said that this measure is a desired measure.

### Modification Aspect

(1) In the present exemplary embodiment, in a case where the rubbing roll 90 is disposed at the release position, the driving of the plurality of rotating bodies 90a and 90b is stopped. However, the rubbing roll 90 may be disposed at the release position without stopping the driving of the plurality of rotating bodies 90a and 90b.
(2) In the present exemplary embodiment, the post-processing device 25 performs the post-processing on the sheet-like medium S, but the present invention is not limited to this, and the post-processing may be performed on a continuous medium such as a roll-like medium. In this case, unlike the sheet-like medium S, the transport roll 80 can always maintain a state where the continuous medium S is nipped. Therefore, for example, this configuration is preferable in that a timing of the nip release of the rubbing roll 90 is controlled, so that the rubbing processing using the rubbing roll 90 can be appropriately carried out on a portion of the continuous medium that requires the rubbing processing.

### Exemplary Embodiment 2

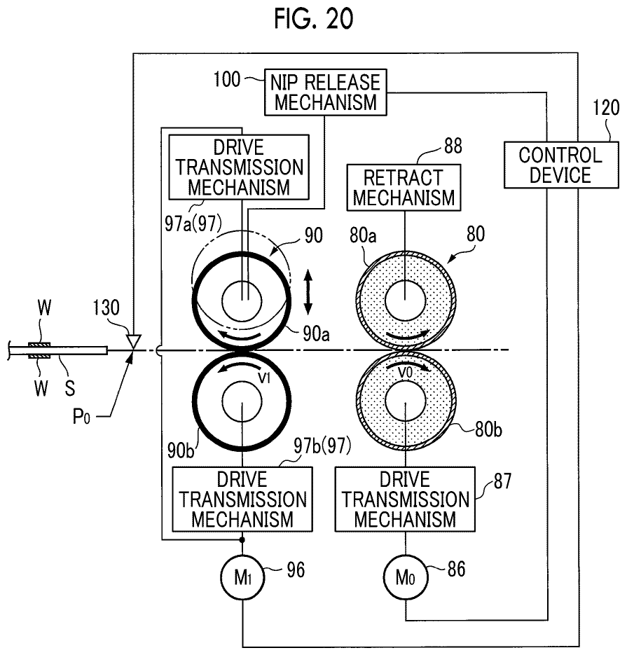

FIG. 20 is a diagram showing a major portion of the post-processing device according to Exemplary Embodiment 2.

### Basic Configuration of Post-Processing Device

In the same drawing, the post-processing device 25 includes the transport roll 80 as the transport section that transports the subsequent medium S at the transport speed v0, by nipping the medium S, as in Exemplary Embodiment 1. However, unlike Exemplary Embodiment 1, the post-processing device 25 includes the rubbing roll 90 as the rubbing section that is located upstream of the transport roll 80 in the transport direction of the medium S and that rubs the surface of the medium S in a direction opposite to the transport direction of the medium S at the speed v1 different from the transport speed v0.

In the present example, the rubbing roll 90 is configured to rub both the front and back surfaces of the medium S.

In FIG. 20, reference numeral 120 is a control device that controls the respective elements of the image forming system 20, and reference numeral 130 is a position sensor for detecting a transport position of the medium S.

### Transport Roll

### Configuration Example and Drive Method of Transport Roll

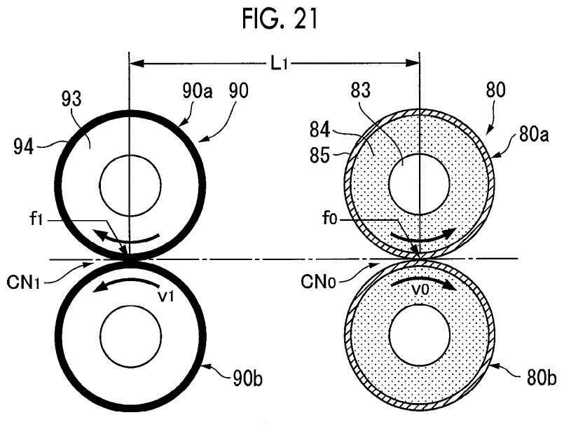

In the present example, as shown in FIGS. 20 and 21, the transport roll 80 consists of the plurality of rotating bodies 80a and 80b that are disposed to face each other with respect to the medium S. The rotating bodies 80a and 80b constituting the transport roll 80 have a three-layer structure including the shaft 83, the elastic layer 84, and the mold-releasing layer 85, as in Exemplary Embodiment 1.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, in the same manner as in Exemplary Embodiment 1.

### Retract Configuration Example of Transport Roll

In the present example, as shown in FIGS. 20, 8A, and 8B, the retract mechanism 88 (support shaft 88a, support arms 88b, and operation lever 88c) as the retract section as in Exemplary Embodiment 1 is provided in one rotating body 80a of the transport roll 80.

### Setting of Nip Pressure of Transport Roll

As in Exemplary Embodiment 1, the biasing springs 114 as the biasing sections for adjusting the nip pressure (corresponding to the contact pressure of the contact region CN0 between the plurality of rotating bodies 80a and 80b) of the transport roll 80 are provided at both ends of one rotating body 80a of the transport roll 80 (see FIG. 8A). The biasing spring 114 is composed of, for example, a compression coil spring, and adjusts the compression deformation amount via an adjustment portion (not shown).

### Rubbing Roll

### Configuration Example of Rubbing Roll

In the present example, as in Exemplary Embodiment 1, the rubbing roll 90 consists of the plurality of rotating bodies 90a and 90b that are disposed to face each other with respect to the medium S. In the present example, the rotating bodies 90a and 90b constituting the rubbing roll 90 need only have, at least on a surface, a rubbing portion 94 for rubbing the wax W.

In the present example, as in Exemplary Embodiment 1, the roll body 93 is formed by laminating an elastic layer 93b such as silicone rubber around a metal shaft 93a. In addition, the rubbing portion 94 can be formed by using a member that performs the rubbing effect.

In the present example, the rubbing portion 94 is configured in substantially the same manner as in Exemplary Embodiment 1.

Drive method of Rubbing Roll

In addition, in the present example, the rubbing roll 90 uses both the rotating bodies 90a and 90b as driving rolls. That is, a drive force from a drive motor 96 is transmitted to both the rotating bodies 90a and 90b via drive transmission mechanisms 97 (specifically, 97a and 97b) such as drive transmission gear trains. Here, the drive transmission mechanisms 97a and 97b may be partially shared or may be separately provided. In the present example, the drive transmission mechanism 97b shares the drive transmission mechanism 97a, and is configured to add a transmission gear for changing a rotation direction with respect to a transmission gear of the final stage of the drive transmission mechanism 97a.

### Speed Condition of Rubbing Roll

As shown in FIGS. 20 and 21, the rubbing roll 90 need only rub the surface of the medium S in the direction opposite to the transport direction of the medium S at the speed v1 different from the transport speed v0 of the transport roll 80.

In the present example, the rubbing roll 90 is selected so as (i) to rotate in the direction opposite to the transport direction of the medium S in a contact region CN1 between the plurality of rotating bodies 90a and 90b. That is, the rotating body 90a located on the upper side rotates in a clockwise direction, and the rotating body 90b located on the lower side rotates in a counterclockwise direction.

The reason for the selection is based on the viewpoint that the rubbing resistance caused by the rubbing roll 90 is increased. In a case of such a selection, a speed difference (v0−v1) between the rubbing roll 90 and the transport roll 80 can be increased. Here, the speed v1 of the rubbing roll 90 may be selected as appropriate, but is set to about 5 to 10 times v0 in the absolute value in the present example.

In order to rub the surface of the medium S via the rubbing roll 90 in the direction opposite to the transport direction of the medium S, in addition to (i), the rubbing roll 90 may be selected so as (ii) to maintain a stop state in the contact region CN1 or (iii) to rotate in the same direction as the transport direction of the medium S at the speed that is lower than the transport speed v0 of the medium S in the contact region CN1. However, it should be noted that the rubbing resistance caused by the rubbing roll 90 is smaller in the methods of (ii) and (iii) than in the method of (i).

### Contact/Separation Configuration Example of Rubbing Roll

In the present example, the rubbing roll 90 includes the nip release mechanism 100, as in Exemplary Embodiment 1. As shown in FIGS. 20, 9A, and 9B, the nip release mechanism 100 supports both ends of the shaft 93 of the rotating body 90a, and switches between the nip state of the rubbing roll 90 (corresponding to the contact state between the plurality of rotating bodies 90a and 90b) and the release state (corresponding to the non-contact state between the plurality of rotating bodies 90a and 90b) based on the control signal.

In the present example, as shown in FIGS. 9B and 9C, the nip release mechanism 100 includes the same constituent elements (support shaft 103, support arms 104, and nip release motor 105) as in Exemplary Embodiment 1.

### Setting of Nip Pressure of Rubbing Roll

In the present example, as shown in FIGS. 9A and 9D, biasing springs 117 as the biasing sections for adjusting the nip pressure (corresponding to the contact pressure of the contact region of the plurality of rotating bodies 90a and 90b) of the rubbing roll 90 are provided in the rubbing roll 90, as in Exemplary Embodiment 1. In addition, an adjustment portion 118 that adjusts the compression deformation amount is provided in the biasing spring 117. The adjustment portion 118 variably sets the biasing force of the biasing spring 117 by adjusting the compression deformation amount.

### Adjustment of Frictional Force of Rubbing Roll

In the present example, the rubbing roll 90 and the transport roll 80 come into contact with the medium S that moves. In this case, in a case where the medium S passes through the contact region CN1 of the rubbing roll 90, as shown in FIG. 21, the frictional force f1 is generated between the rubbing roll 90 and the medium S. Meanwhile, in a case where the medium S passes through the contact region CN0 of the transport roll 80, a frictional force f0 is generated between the transport roll 80 and the medium S.

In the present example, the frictional force f0 between the plurality of rotating bodies 80a and 80b constituting the transport roll 80 and the medium S is required to be greater than the frictional force f1 between the plurality of rotating bodies 90a and 90b constituting the rubbing roll 90 and the medium S.

Here, in a case where a normal force acting on the contact region CN0 of the transport roll 80 is denoted by U0, a kinetic friction coefficient between the transport roll 80 and the medium S is denoted by μ0, a normal force acting on the contact region CN1 of the rubbing roll 90 is denoted by U1, and a kinetic friction coefficient between the rubbing roll 90 and the medium S is denoted by μ1, the relationship is represented as follows.

f0=μ0·U0

f1=μ1·U1

In order to satisfy the condition of f0>f1, since the kinetic friction coefficients μ0 and μ1 are values dependent on the materials and the like, the biasing forces of the biasing springs 114 and 117 that affect the normal forces U0 and U2 need only be adjusted in consideration of the respective kinetic friction coefficients. Here, since U0 is selected such that the transportability of the medium S is ensured at an appropriate level, it is preferable to mostly adjust the biasing force of the biasing spring 117 and appropriately adjust the frictional force f1.

### Operation of Post-Processing Device

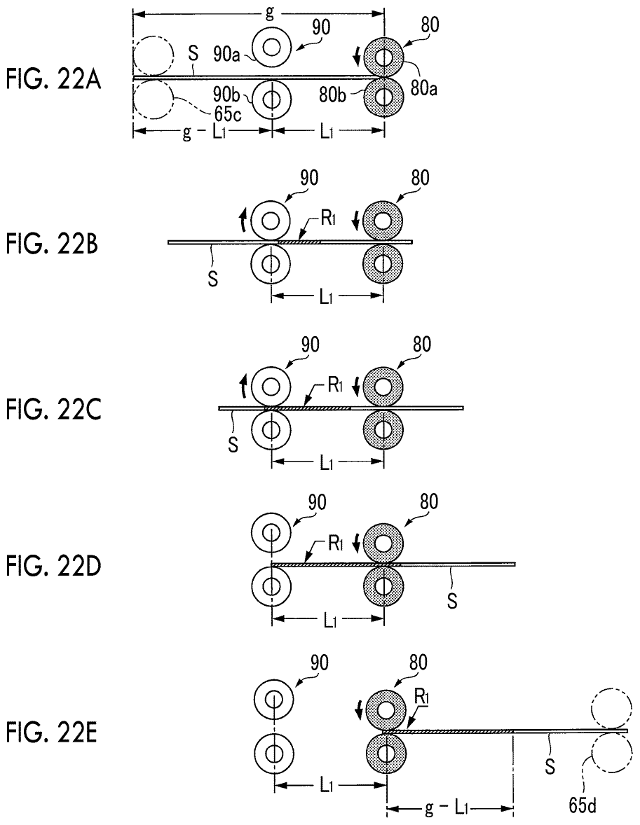

In the present example, the control device 120 executes control processing of the post-processing device 25, as shown in FIGS. 22A to 22E.

In the same drawing, a distance between the rubbing roll 90 and the transport roll 80 is denoted by L1, and the transport direction length of the medium S is denoted by g.

FIG. 22A shows a state where a leading end part of the medium S enters the transport roll 80. In this case, the medium S is transported by the transport roll 65c for feeding located on the inlet side of the post-processing device 25, slips through the rubbing roll 90 located at a release position, and enters the transport roll 80.

FIG. 22B shows a state after the leading end part of the medium S has entered the transport roll 80. In this case, the rubbing roll 90 is disposed at a nip position to start the driving. Then, the medium S is transported in a state of being pulled in the transport direction between the rubbing roll 90 and the transport roll 80. Then, the rubbing operation using the rubbing roll 90 is carried out from the middle of the medium S in the transport direction. In FIG. 22B, R1 indicates a rubbing region (corresponding to a hatched region in the diagonally lower left in the drawing) of the rubbing roll 90 with respect to the medium S.

FIG. 22C shows a state where the medium S is further transported by the transport roll 80. In this case, the rubbing operation using the rubbing roll 90 is continuously carried out.

FIG. 22D shows a state where the trailing end part of the medium S passes through the rubbing roll 90. In this case, the rubbing roll 90 is disposed at the release position, and the driving is stopped. During this period, the rubbing operation using the rubbing roll 90 is carried out from the middle of the medium S in the transport direction to the trailing end part of the medium S.

FIG. 22E shows a state immediately before the trailing end part of the medium S passes through the transport roll 80. In this case, the leading end part of the medium S is nipped and transported by the transport roll 65d located on the outlet side of the post-processing device 25. Therefore, the transportability of the medium S discharged from the post-processing device 25 is well maintained.

As described above, in the present example, the post-processing device 25 rubs both the front and back surfaces of the medium S in the rubbing region R1 of the rubbing roll 90.

### Form Change in Wax on Medium Before and After Post-Processing

In the present exemplary embodiment as well, it is confirmed that the form of the wax W changed from the granular mass Wa to the thin film-like layer Wb before and after the post-processing using the post-processing device 25. In this case, it is confirmed that, in a case where the wax W after the post-processing is changed to the thin film-like layer Wb having the thickness tr equal to or less than 0.15 μm, the wax W is hardly visible to the naked eye.

In the present example as well, in the present exemplary embodiment, the configuration of the rubbing portion 94 of the rubbing roll 90 is devised, so that the rubbing operation effect of the rubbing roll 90 is uniform, and no problems such as hair pulling, which occurs in a case where felt or pile fabric is used as the cloth material from the rubbing portion 94, are observed.

### Exemplary Embodiment 3

### Basic Configuration of Post-Processing Device

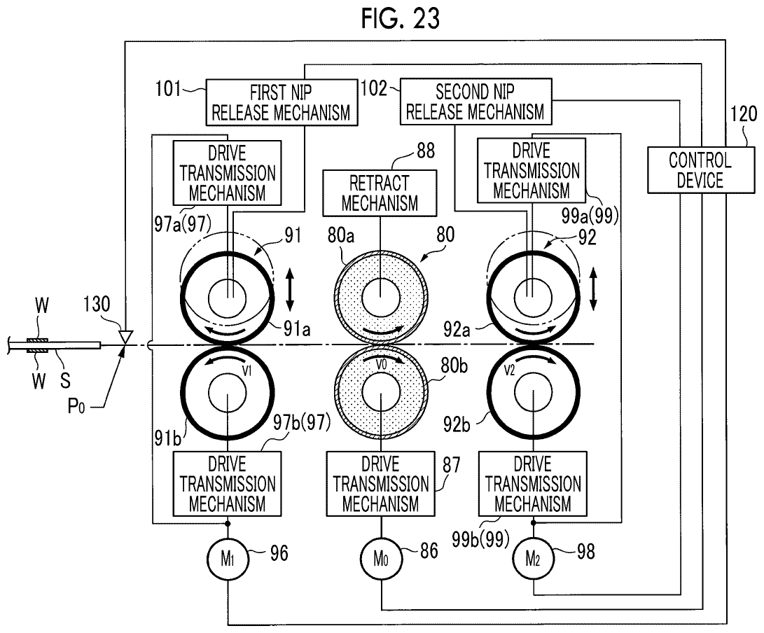

FIG. 23 is a diagram showing a major portion of the post-processing device according to Exemplary Embodiment 3.

In the same drawing, the post-processing device 25 is a combination of the post-processing device 25 (see FIG. 6) of the disposition example according to Exemplary Embodiment 1 and the post-processing device 25 (see FIG. 20) of the disposition example according to Exemplary Embodiment 2.

In the present example, as shown in FIG. 23, the post-processing device 25 includes the transport roll 80 as the transport section that transports the medium S at the predetermined transport speed v0 by nipping the medium S, a first rubbing roll 91 as the rubbing section that is located upstream of the transport roll 80 in the transport direction of the medium S and that rubs the surface of the medium S in a direction opposite to the transport direction of the medium S at the speed v1 that is different from the transport speed v0, and a second rubbing roll 92 as the rubbing section that is located downstream of the transport roll 80 in the transport direction of the medium S and that rubs the surface of the medium S in the same direction as the transport direction of the medium S at the speed v2 that is higher than the transport speed v0, and the transport roll 80, the first rubbing roll 91, and the second rubbing roll 92 are mounted in a housing (not shown) in an appropriate arrangement.

In the present example, the first rubbing roll 91 and the second rubbing roll 92 are configured to rub both the front and back surfaces of the medium S.

### Transport Roll

### Configuration Example and Drive Method of Transport Roll

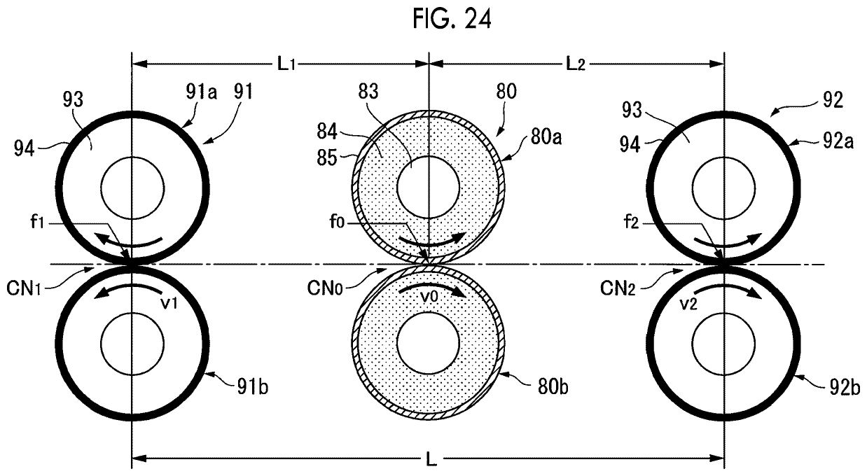

In the present example, as shown in FIGS. 23 and 24, the transport roll 80 consists of the plurality of rotating bodies 80a and 80b that are disposed to face each other with respect to the medium S. The plurality of rotating bodies 80a and 80b constituting the transport roll 80 have a three-layer structure including a shaft 83, an elastic layer 84, and a mold-releasing layer 85, as in Exemplary Embodiments 1 and 2.

In the present example, the drive method of the transport roll 80 is a method of using one rotating body 80b of the plurality of rotating bodies 80a and 80b as a driving roll, and transmitting a drive force from the drive motor 86 to the driving roll via the drive transmission mechanism 87, in substantially the same manner as in Exemplary Embodiments 1 and 2.

### Retract Configuration Example of Transport Roll

In the present example, as shown in FIGS. 23, 8A, and 8B, the retract mechanism 88 (support shaft 88a, support arms 88b, and operation lever 88c) as the retract section as in Exemplary Embodiments 1 and 2 is provided in one rotating body 80a of the transport roll 80.

### Setting of Nip Pressure of Transport Roll

As in Exemplary Embodiment 1, the biasing springs 114 as the biasing sections for adjusting the nip pressure (corresponding to the contact pressure of the contact region CN0 between the plurality of rotating bodies 80a and 80b) of the transport roll 80 are provided at both ends of one rotating body 80a of the transport roll 80 (see FIG. 8A). The biasing spring 114 is composed of, for example, a compression coil spring, and adjusts the compression deformation amount via an adjustment portion (not shown).

### First Rubbing Roll

### Configuration Example of First Rubbing Roll

In the present example, as shown in FIGS. 23 and 24, the first rubbing roll 91 consists of a plurality of rotating bodies 91a and 91b that are disposed to face each other with respect to the medium S. In the present example, the rotating bodies 91a and 91b constituting the first rubbing roll 91 have rubbing portions 94 around the roll body 93, in the same manner as the rubbing roll 90 of Exemplary Embodiment 2.

The rubbing portion 94 is also configured in substantially the same manner as in the rubbing portion of Exemplary Embodiment 2.

### Drive Method of First Rubbing Roll

In the present example, the first rubbing roll 91 uses both the rotating bodies 91a and 91b as driving rolls. That is, the same drive method as the drive method of the rubbing roll 90 according to Exemplary Embodiment 2 (drive motor 96 and drive transmission mechanism 97 (97a and 97b)) is adopted for both the rotating bodies 91a and 91b.

### Speed Condition of First Rubbing Roll

As shown in FIGS. 23 and 24, the first rubbing roll 91 has the same speed condition as the rubbing roll 90 according to Exemplary Embodiment 2. Specifically, the first rubbing roll 91 need only rub the surface of the medium S in the direction opposite to the transport direction of the medium S at the speed v1 different from the transport speed v0 of the transport roll 80.

### Contact/Separation Configuration Example of First Rubbing Roll

In the present example, as shown in FIGS. 23, 9A, and 9B, one rotating body 91a of the first rubbing roll 91 is provided with a first nip release mechanism 101 as the contact/separation section that is movable between the contact position at which the rotating body 91a is in contact with the other rotating body 91b and the non-contact position at which the rotating body 91a is separated from the contact position. The first nip release mechanism 101 supports both ends of the shaft 93 of the rotating body 91a, and switches between the nip state of the first rubbing roll 91 (corresponding to the contact state between the plurality of rotating bodies 91a and 91b) and the release state (corresponding to the non-contact state between the plurality of rotating bodies 91a and 91b) based on the control signal. In the present example, as shown in FIGS. 23 and 9B, the first nip release mechanism 101 has the same configuration (support shaft 103, support arms 104, and nip release motor 105) as the nip release mechanism 100 according to Exemplary Embodiment 2.

### Setting of Nip Pressure of First Rubbing Roll

In the present example, as shown in FIGS. 9A and 9D, biasing springs 115 as the biasing sections for adjusting the nip pressure (corresponding to the contact pressure of the contact region of the plurality of rotating bodies 91a and 91b) of the first rubbing roll 91 are provided in the first rubbing roll 91, as in the rubbing roll 90 according to Exemplary Embodiment 2. The biasing spring 115 is composed of, for example, a compression coil spring. An adjustment portion 116 that adjusts the compression deformation amount is provided in the biasing spring 115.

### Adjustment of Frictional Force of First Rubbing Roll

In the present example, the first rubbing roll 91 corresponds to the rubbing roll 90 according to Exemplary Embodiment 2.

Therefore, in the present example, the frictional force f0 between the plurality of rotating bodies 80a and 80b constituting the transport roll 80 and the medium S is required to be greater than the frictional force f1 between the plurality of rotating bodies 91a and 91b constituting the first rubbing roll 91 and the medium S.

### Second Rubbing Roll

### Configuration Example of Second Rubbing Roll

In the present example, as shown in FIGS. 23 and 24, the second rubbing roll 92 consists of a plurality of rotating bodies 92a and 92b that are disposed to face each other with respect to the medium S. In the present example, the rotating bodies 92a and 92b constituting the second rubbing roll 92 have the roll bodies 93 and the rubbing portions 94, as in the first rubbing roll 91.

### Drive Method of Second Rubbing Roll

The second rubbing roll 92 also uses both the rotating bodies 92a and 92b as driving rolls, as in the first rubbing roll 91. That is, the same drive method as the drive method of the rubbing roll 90 according to Exemplary Embodiment 2 (drive motor 98 and drive transmission mechanism 99 (99a and 99b)) is adopted for both the rotating bodies 92a and 92b.

### Speed Condition of Second Rubbing Roll

As shown in FIGS. 23 and 24, the second rubbing roll 92 has the same speed condition as the rubbing roll 90 according to Exemplary Embodiment 1. Specifically, the second rubbing roll 92 need only rub the surface of the medium S in the same direction as the transport direction of the medium S at the speed v2 that is higher than the transport speed v0 of the transport roll 80.

### Contact/Separation Configuration Example of Second Rubbing Roll

In the present example, as shown in FIGS. 23, 9A, and 9B, one rotating body 92a of the second rubbing roll 92 is provided with a second nip release mechanism 102 as the contact/separation section that is movable between a contact position at which the rotating body 92a is in contact with the other rotating body 92b and a non-contact position at which the rotating body 92a is separated from the contact position. The second nip release mechanism 102 supports both ends of the shaft 93 of the rotating body 92a, and switches between the nip state of the second rubbing roll 92 (corresponding to the contact state between the plurality of rotating bodies 92a and 92b) and the release state (corresponding to the non-contact state between the plurality of rotating bodies 92a and 92b) based on the control signal. In the present example, as shown in FIGS. 23 and 9B, the second nip release mechanism 102 has the same configuration (support shaft 103, support arms 104, and nip release motor 105) as the nip release mechanism 100 according to Exemplary Embodiment 1.

### Setting of Nip Pressure of Second Rubbing Roll

In the present example, as shown in FIGS. 9A and 9D, biasing springs 117 as the biasing sections for adjusting the nip pressure (corresponding to the contact pressure of the contact region of the plurality of rotating bodies 92a and 92b) of the second rubbing roll 92 are provided in the second rubbing roll 92, as in the rubbing roll 90 according to Exemplary Embodiment 1. The biasing spring 117 is composed of, for example, a compression coil spring. An adjustment portion 118 that adjusts the compression deformation amount is provided in the biasing spring 117.

### Adjustment of Frictional Force of Second Rubbing Roll

In the present example, the second rubbing roll 92 corresponds to the rubbing roll 90 according to Exemplary Embodiment 1.

Therefore, in the present example, the frictional force f0 between the plurality of rotating bodies 80a and 80b constituting the transport roll 80 and the medium S is required to be greater than the frictional force f2 between the plurality of rotating bodies 92a and 92b constituting the second rubbing roll 92 and the medium S.

Positional Relationship among Transport Roll and First and Second Rubbing Rolls

In the present example, the positional relationship among the transport roll 80, the first rubbing roll 91, and the second rubbing roll 92 is as follows.

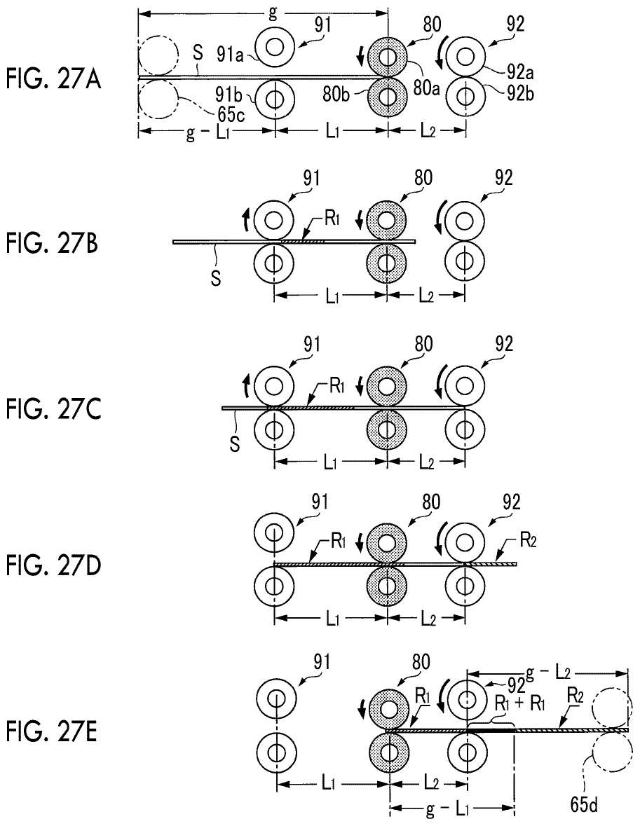

As shown in FIG. 24, in a case where a distance between a circumferential center of the contact region CN1 of the first rubbing roll 91 and a circumferential center of the contact region CN2 of the second rubbing roll 92 is denoted by L, a distance between the circumferential center of the contact region CN1 of the first rubbing roll 91 and a circumferential center of the contact region CN0 of the transport roll 80 is denoted by L1, a distance between the circumferential center of the contact region CN0 of the transport roll 80 and the circumferential center of the contact region CN2 of the second rubbing roll 92 is denoted by L2, and the transport direction length of the medium S is denoted by g (see FIG. 27A), the selection is made such that Expressions (I) and (II) are satisfied.

L<g (I)

L1,L2<g/2 (II)

Here, L=L1+L2.

The circumferential center of the contact region CN0 (CN1 or CN2) refers to an intersection between a straight line connecting axis centers of the plurality of rotating bodies 80a and 80b (91a and 91b, or 92a and 92b) and the contact region CN0 (CN1 or CN2).

In the present example, Expression (I) is a condition for rubbing the entire region of both the front and back surfaces of the medium S via the first rubbing roll 91 and the second rubbing roll 92.

In addition, Expression (II) is a condition for both the first rubbing roll 91 and the second rubbing roll 92 to rub a region covering more than half of both the front and back surfaces of the medium S.

In particular, in Expression (II), since L1 and L2 are less than half of the transport direction length g of the medium S, it is possible to stably transport the medium S while maintaining the transport posture of the medium S without providing the guide member or the like in the transport path of the medium S in the post-processing device 25.

In addition, in the present example, in the horizontal transport path 64, a transport roll 65c for feeding to the post-processing device 25 is disposed upstream of the post-processing device 25 in the transport direction of the medium S. On the other hand, a transport roll 65d for reception from the post-processing device 25 is disposed downstream of the post-processing device 25 in the transport direction of the medium S.

Here, in order to transport the medium S at the transport speed v0 via the transport roll 65c for feeding, the transport roll 80, and the transport roll 65d for reception, it is necessary to set an inter-roll distance among the transport roll 65c for feeding, the transport roll 80, and the transport roll 65d for reception (specifically, a distance between the circumferential centers of the contact regions of the adjacent rolls) to be shorter than the transport direction length g of the medium S.

### Control System of Post-Processing Device

In the present exemplary embodiment, as shown in FIG. 23, a control device 120 that controls the respective elements (imaging engine 22, medium transport system 23, fixing device 24, post-processing device 25, and the like) of the image forming system 20 is provided.

In the present example, in the horizontal transport path 64, a position sensor 130 as a position detection section is provided upstream of the post-processing device 25 in the transport direction of the medium S.

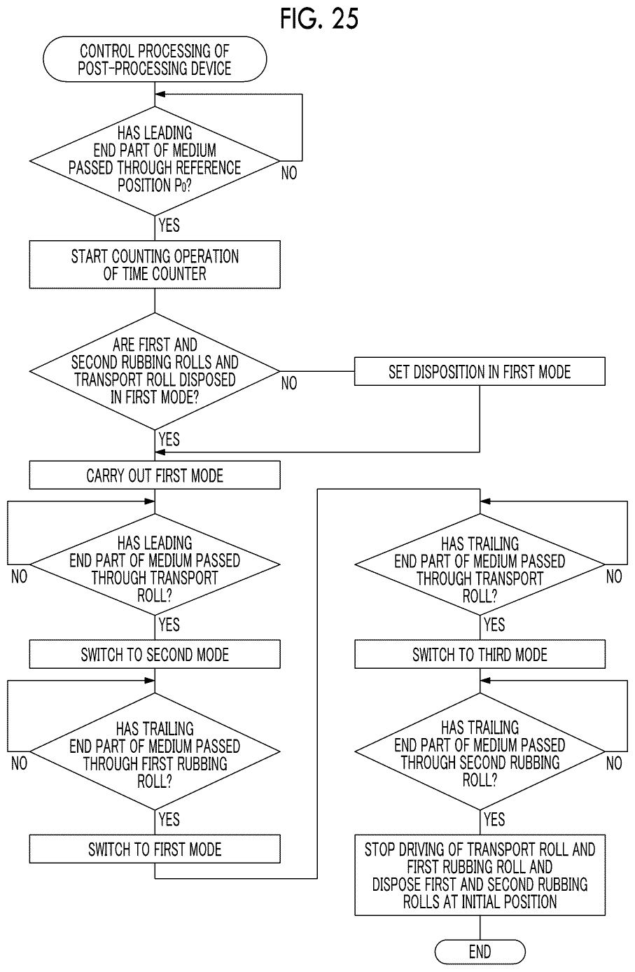

In the present example, the control device 120 is a device in which required programs, such as the imaging program of the image forming system 20 and the control processing program (see FIG. 25) of the post-processing device 25, are installed in advance in a memory (not shown). The control device 120 executes the imaging program by turning on a start switch (not shown), and sends out a control signal required for imaging processing to the imaging engine 22, the medium transport system 23, and the fixing device 24.

Further, it is assumed that the leading end part of the medium S, which has passed through the fixing device 24, passes through the position sensor 130. In this case, the control device 120 imports detection information from the position sensor 130 into the processor, and executes the control processing program of the post-processing device 25. Then, the control device 120 sends out a control signal for nip release to the first nip release mechanism 101 and the second nip release mechanism 102. Further, the control device 120 sends out a control signal for driving to each of the drive motors 86, 96, and 98 of the transport roll 80, the first rubbing roll 91, and the second rubbing roll 92.

### Operation of Post-Processing Device

In the present example, the control device 120 executes control processing of the post-processing device 25, as shown in FIG. 25.

In FIG. 25, the control device 120 determines whether or not the leading end part of the medium S that has passed through the fixing device 24 has passed through a predetermined reference position P0. In the present example, the control device 120 determines that the leading end part of the medium S has passed through the reference position P0, based on the detection signal from the position sensor 130.

Then, the control device 120 starts a counting operation of an internal time counter and uses the counting operation for discriminating the transport position of the medium S.

### First Mode

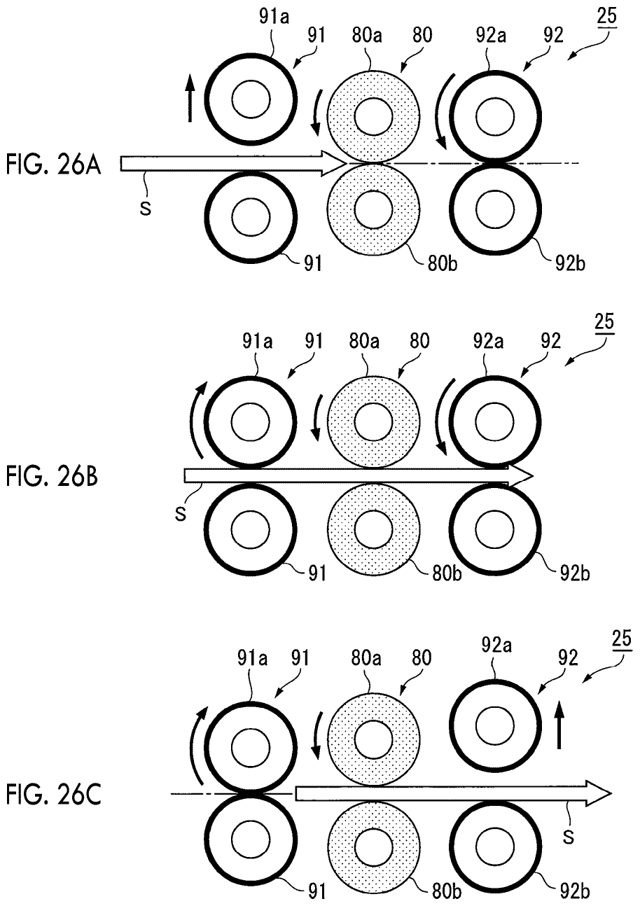

Thereafter, the control device 120 determines whether or not the first rubbing roll 91, the second rubbing roll 92, and the transport roll 80 are disposed as in a first mode. Here, the “first mode” referred to here refers to an operation behavior shown in FIG. 26A. In this case, the first rubbing roll 91 is disposed at the release position, the transport roll 80 and the second rubbing roll 92 are disposed at the nip position. The transport roll 80 and the second rubbing roll 92 located at the nip position are driven.

In the present example, in a case of the disposition in the first mode, the first mode is carried out. In a case of not the disposition in the first mode, the control device 120 disposes the first mode and then carries out the first mode.

In this state, the transport roll 80 rotates idly at the predetermined transport speed v0 at the nip position. The second rubbing roll 92 rotates idly at the speed v2 (v2>v0) in the same direction as the transport roll 80 at the nip position. On the other hand, the first rubbing roll 91 stops the driving at the release position and is in a standby state.

On the other hand, the medium S passes through the position sensor 130 via the transport roll 65c for feeding (see FIG. 3), and is transported into the post-processing device 25. Then, the medium S slips as it is through the first rubbing roll 91 and is directed toward the transport roll 80.

### Switching to Second Mode

Next, the control device 120 determines whether or not the leading end part of the medium S has passed through the transport roll 80. Then, in a case where it is determined that the leading end part of the medium S has passed through the transport roll 80, the control device 120 performs switching to a second mode. Here, the “second mode” referred to here refers to an operation behavior shown in FIG. 26B. In this case, unlike the first mode, the first rubbing roll 91 is switched to the nip position to start the driving. The transport roll 80 and the second rubbing roll 92 are the same as in the first mode.

In this state, immediately after the medium S has entered the transport roll 80, the first rubbing roll 91 nips a middle portion of the medium S in the transport direction and rotates in the direction opposite to the transport roll 80 at the speed v1 (|v1|>v0).

Therefore, the medium S is transported in a state of being pulled in the transport direction between the first rubbing roll 91 and the transport roll 80. In this case, a relationship between the frictional force f1 between the first rubbing roll 91 and the medium S and the frictional force f0 between the transport roll 80 and the medium S is f1<f0. Therefore, the medium S is transported by the transport roll 80 at the transport speed v0. In this state, in a case where the first rubbing roll 91 rotates in the opposite direction at the speed v1 in the contact region CN1, the surface of the medium S is rubbed in the direction opposite to the transport direction of the medium S. As a result, the rubbing operation using the first rubbing roll 91 is continued until the trailing end of the medium S in the transport direction passes through the first rubbing roll 91. Therefore, the rubbing region R1 of the first rubbing roll 91 is a rear half region of the medium S from the middle of the medium S in the transport direction to the trailing end of the medium S in the transport direction (see FIGS. 27A to 27F).

In the second mode, in a case where the leading end part of the medium S reaches the second rubbing roll 92, the following behavior is exhibited. In the present example, in a case where the medium S enters the second rubbing roll 92, the second rubbing roll 92 nips the leading end part of the medium S, and rotates in the same direction as the transport roll 80 at the speed v2 (v2>v0).

Therefore, the medium S is transported in a state of being pulled in the transport direction between the transport roll 80 and the second rubbing roll 92. In this case, a relationship between the frictional force f2 between the second rubbing roll 92 and the medium S and the frictional force f0 between the transport roll 80 and the medium S is f2<f0. Therefore, the medium S is transported by the transport roll 80 at the transport speed v0. In this state, in a case where the second rubbing roll 92 rotates in the same direction at the speed v2 in the contact region CN2, the surface of the medium S is rubbed in the same direction as the transport direction of the medium S. As a result, the rubbing operation using the second rubbing roll 92 is continued from the leading end part of the medium S to immediately before the medium S passes through the transport roll 80. Therefore, the rubbing region R2 of the second rubbing roll 92 is a front half region of the medium S from the leading end part of the medium S to the middle of the medium S in the transport direction (see FIGS. 27A to 27E).

### Switching to First Mode

Next, the control device 120 determines whether or not a trailing end part of the medium S has passed through the first rubbing roll 91. In this case, in a case where the control device 120 determines that the trailing end part of the medium S has passed through the first rubbing roll 91, the control device 120 performs switching to the first mode. As a result, the first rubbing roll 91 is disposed at the release position and the driving is stopped.

This is because, in a case where the trailing end part of the medium S passes through the first rubbing roll 91, there is no longer any medium S as the rubbing target of the first rubbing roll 91. In the present example, the switching to the first mode is performed from the viewpoint of performing the preparation for receiving the subsequent medium Sr in advance.

### Switching to Third Mode

Thereafter, the control device 120 determines whether or not the trailing end part of the medium S has passed through the transport roll 80. Then, in a case where it is determined that the trailing end part of the medium S is immediately before passing through the transport roll 80, the control device 120 performs switching to a third mode. Here, the “third mode” referred to here refers to an operation behavior shown in FIG. 26C. In this case, the third mode refers to the operation behavior of stopping the driving by switching the second rubbing roll 92 to the release position, unlike the first mode and the second mode. In this case, the first rubbing roll 91 and the transport roll 80 need only be the same as any one of the first mode or the second mode. FIG. 26C shows a state where the first rubbing roll 91 is the same as in the second mode.

The third mode is a mode for well maintaining the transportability of the medium S discharged from the post-processing device 25. In a case where the rubbing operation using the second rubbing roll 92 is continued even after the trailing end part of the medium S has passed through the transport roll 80, the medium S is discharged by the second rubbing roll 92 at the speed v2 (v2>v0) at a point in time when the transport operation of the medium S using the transport roll 80 is no longer performed. In this case, the medium S is discharged at the speed v2 that is higher than the predetermined transport speed v0 by the second rubbing roll 92, and thus the transportability of the medium S is impaired.

### Return to Initial Position

Next, the control device 120 determines whether or not the trailing end part of the medium S has passed through the second rubbing roll 92. In the present example, in a case where it is determined that the trailing end part of the medium S has passed through the second rubbing roll 92, the control device 120 stops the driving of the transport roll 80 and the first rubbing roll 91, and disposes the first rubbing roll 91 and the second rubbing roll 92 at the initial positions. In the present example, the initial position is selected, for example, as the disposition in the first mode (the first rubbing roll 91 is at the release position and the second rubbing roll 92 is at the nip position).

### Specific Example of Wax Rubbing Processing Using Post-Processing Device

In the present example, the distance L1 between the first rubbing roll 91 and the transport roll 80 and the distance L2 (see FIG. 24) between the transport roll 80 and the second rubbing roll 92 may be selected as appropriate such that Expression (I): L1+L2=L<g (length of medium S in transport direction) and Expression (II): L1, L2<g/2 are satisfied.

Therefore, representative examples thereof include an aspect in which L1=L2, but hereinafter, Specific Example 1 (case of L1>L2) will be described.

FIGS. 27A to 27E show the wax rubbing processing using the post-processing device 25 in Specific Example 1.

FIG. 27A shows a state where the leading end part of the medium S enters the transport roll 80. In this case, since the first mode is carried out, the medium S is transported by the transport roll 65c for feeding located on the inlet side of the post-processing device 25, slips through the first rubbing roll 91 located at the release position, and enters the transport roll 80.

FIG. 27B shows a state after the leading end part of the medium S has entered the transport roll 80. In this case, the second mode is carried out, so that the first rubbing roll 91 is disposed at the nip position to start the driving. Then, the rubbing operation using the first rubbing roll 91 is carried out from the middle of the medium S in the transport direction. In FIG. 27B, R1 indicates a rubbing region (corresponding to a hatched region in the diagonally lower left in the drawing) of the first rubbing roll 91 with respect to the medium S.

FIG. 27C shows a state where the leading end part of the medium S has entered the second rubbing roll 92. In this case, since the second mode is still being carried out, the rubbing operation using the second rubbing roll 92 is started from the leading end part of the medium. The rubbing operation using the first rubbing roll 91 is continuously carried out.

FIG. 27D shows a state where the trailing end part of the medium S passes through the first rubbing roll 91. In this case, the switching to the first mode is performed, the first rubbing roll 91 is disposed at the release position, and the driving is stopped. During this period, the rubbing operation using the first rubbing roll 91 is carried out from the middle of the medium S in the transport direction to the trailing end part of the medium S. In addition, the rubbing operation using the second rubbing roll 92 is carried out from the leading end part of the medium S toward the downstream side of the medium S in the transport direction. In FIG. 27D, R2 indicates a rubbing region (corresponding to a hatched region in the diagonally lower right in the drawing) of the second rubbing roll 92 with respect to the medium S.

FIG. 27E shows a state immediately before the trailing end part of the medium S passes through the transport roll 80. In this case, the switching to the third mode is performed, the second rubbing roll 92 is disposed at the release position, and the driving is stopped. During this period, the rubbing operation using the second rubbing roll 92 is carried out from the leading end part of the medium S to the middle of the medium S in the transport direction. The rubbing operation using the second rubbing roll 92 is stopped at a stage in which the second rubbing roll 92 is disposed at the release position. In FIG. 27E, the rubbing region R2 of the second rubbing roll 92 is provided substantially within a g-L2 range. On the other hand, the rubbing region R1 of the first rubbing roll 91 is provided substantially within the g-L1 range.

In addition, in a case where the switching to the third mode is performed, the leading end part of the medium S is nipped and transported by the transport roll 65d located on the outlet side of the post-processing device 25. Therefore, the transportability of the medium S discharged from the post-processing device 25 is well maintained.

As described above, in the present example, as shown in FIG. 27E, in the wax post-processing using the post-processing device 25, both the front and back surfaces of the medium S are rubbed in the rubbing region R1 of the first rubbing roll 91 and the rubbing region R2 of the second rubbing roll 92. In the present example, since R1+R2=2g−L (g>L) is satisfied, it is understood that the wax post-processing using the post-processing device 25 is realized with the entire region of both the front and back surfaces of the medium S as the rubbing target. In addition, in the present example, the rubbing regions R1 and R2 are in a partially overlapping state in the middle portion of the transport direction of the medium S, and the relationship of R2>R1 is satisfied.

As described above, in the present exemplary embodiment, the wax post-processing using the post-processing device 25 is effective in that the entire region of both the front and back surfaces of the medium S can be used as the rubbing target.

In the present exemplary embodiment as well, as in Exemplary Embodiments 1 and 2, it is confirmed that the form of the wax W changed from the granular mass Wa to the thin film-like layer Wb before and after the post-processing using the post-processing device 25. In this case, in order to make the wax W after the post-processing less visible, for example, it is desired that the wax W is changed to the thin film-like layer Wb having the thickness tr of equal to or less than 0.15 μm.

In addition, in the present exemplary embodiment as well, in the present exemplary embodiment, the configuration of the rubbing portions 94 of the first rubbing roll 91 and the second rubbing roll 92 is devised, so that the rubbing operation effect of the rubbing roll 90 is uniform, and no problems such as hair pulling, which occurs in a case where felt or pile fabric is used as the cloth material from the rubbing portion 94, are observed.

### Modification Aspect

(1) In the present exemplary embodiment, in a case where the first rubbing roll 91 (or second rubbing roll 92) is disposed at the release position, the driving of the plurality of rotating bodies 91a and 91b (or 92a and 92b) is stopped. However, the first rubbing roll 91 (or second rubbing roll 92) may be disposed at the release position without stopping the driving of the plurality of rotating bodies 91a and 91b (or 92a and 92b).
(2) In the present exemplary embodiment, the second mode is once switched to the first mode and then switched to the third mode, but the second mode may be switched to the third mode without passing through the first mode.
(3) In the present exemplary embodiment, the disposition of the first mode is selected as the initial position of the post-processing device 25, but the disposition of the second mode (both the first rubbing roll 91 and the second rubbing roll 92 are at the nip position) can also be selected.
(4) In the present exemplary embodiment, the aspect is adopted in which the first rubbing roll 91 is disposed upstream of the common transport roll 80 in the transport direction of the medium S and the second rubbing roll 92 is disposed downstream of the common transport roll 80 in the transport direction of the medium S, but the present invention is not limited to this, and the first rubbing roll 91 and the second rubbing roll 92 may be disposed with respect to separate transport rolls 80.
(5) In the present exemplary embodiment, the post-processing device 25 uses the sheet-like medium S as a processing target, but the present invention is not limited to this, and a continuous medium may be used as a processing target.

### Exemplary Embodiment 4

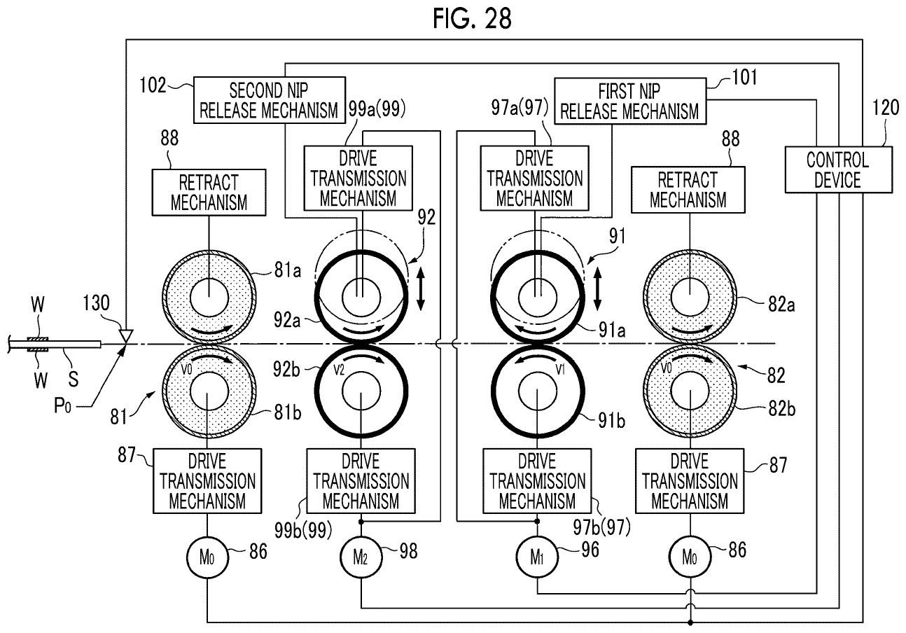

FIG. 28 is a diagram showing a major portion of the post-processing device according to Exemplary Embodiment 4.

In the same drawing, the post-processing device 25 includes a first transport roll 81, a second transport roll 82, the first rubbing roll 91, and the second rubbing roll 92, unlike Exemplary Embodiment 3.

In addition, the same constituent elements as the constituent elements in Exemplary Embodiment 3 are denoted by the same reference numerals of Exemplary Embodiment 3, and the detailed description thereof will be omitted.

Here, the first transport roll 81 transports the medium S that has passed through the fixing device 24, at the predetermined transport speed v0 by nipping the medium S. The second transport roll 82 is located downstream of the first transport roll 81 in the transport direction of the medium S, and transports the medium S at the same speed as the transport speed v0 by nipping the medium S.

Further, the first rubbing roll 91 is located downstream of the first transport roll 81 in the transport direction of the medium S, and is located upstream of the second transport roll 82 in the transport direction of the medium S. The first rubbing roll 91 rubs the surface of the medium S in the direction opposite to the transport direction of the medium S at the speed v1 that is different from the transport speed v0. Further, the second rubbing roll 92 is located downstream of the first transport roll 81 in the transport direction of the medium S, and is located upstream of the first rubbing roll 91 in the transport direction of the medium S. Then, the second rubbing roll 92 rubs the surface of the medium S in the same direction as the transport direction of the medium S at the speed v2 that is higher than the transport speed v0.

In the present example, the first rubbing roll 91 and the second rubbing roll 92 are configured to rub both the front and back surfaces of the medium S, as in Exemplary Embodiment 3. However, unlike Exemplary Embodiment 3, the second rubbing roll 92 is disposed upstream of the first rubbing roll 91 in the transport direction of the medium S. In the present example, the first transport roll 81 and the second rubbing roll 92 have the same effect as the transport roll 80 and the rubbing roll 90 shown in Exemplary Embodiment 1.

Further, the second transport roll 82 and the first rubbing roll 91 have the same action as the transport roll 80 and the rubbing roll 90 shown in Exemplary Embodiment 2.

Therefore, in the present example, the post-processing device 25 according to Exemplary Embodiment 1 and the post-processing device 25 according to Exemplary Embodiment 2 are arranged side by side.

### EXAMPLES

### Example 1

In Example 1, the wax rubbing processing is carried out by using the post-processing device 25 of the image forming system 20 according to Exemplary Embodiment 1.

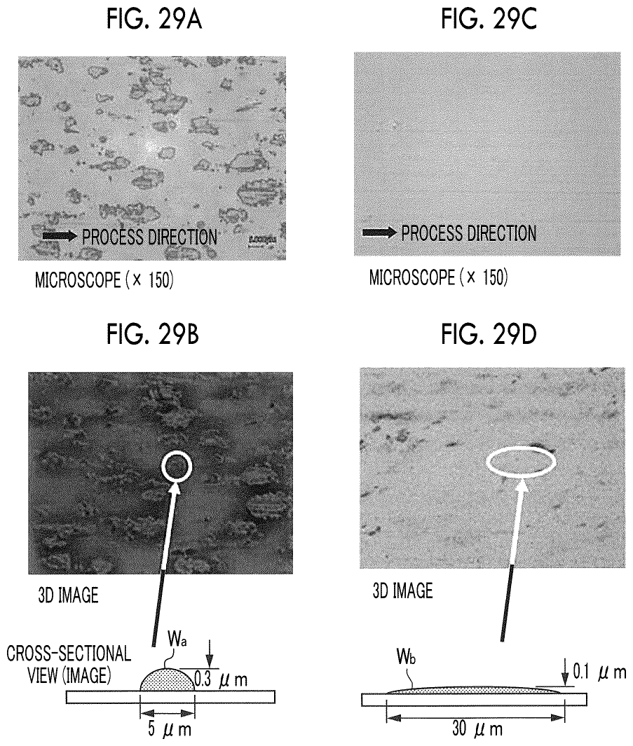

FIG. 29A shows a microscope photograph (×150 times) obtained by imaging a surface state of the medium (transparent film medium is used) that has passed through the fixing device 24 before the post-processing using the post-processing device 25.

FIG. 29C shows a microscope photograph (×150 times) obtained by imaging a surface state of the medium (transparent film medium is used) that has passed through the fixing device after the post-processing using the post-processing device 25.

In a case of evaluating the post-processing using the post-processing device 25, a cross-sectional state of the medium S before the post-processing shown in FIG. 29A is confirmed, and a result as shown in FIG. 29B is obtained.

FIG. 29B shows a 3D image corresponding to the microscopic photograph of FIG. 29A, and a part of the 3D image is displayed in a cross-sectional view. In the same drawing, the wax W transferred to the medium S is confirmed in a large amount as the granular mass Wa (for example, a mass having a radius of 5 μm and a thickness of about 0.3 μm). In this case, the reflected light or the transmitted light to the medium S is scattered by the granular mass Wa, and is visualized. Such a granular mass Wa may be conspicuous as a surface contamination of the medium S, and the image formed using the toner may lead to the image defect.

On the other hand, as shown in FIG. 29C, a cross-sectional state of the medium S after the post-processing using the post-processing device 25 is confirmed, and a result as shown in FIG. 29D is obtained.

FIG. 29D shows a 3D image corresponding to the microscopic photograph of FIG. 29C, and a part of the 3D image is displayed in a cross-sectional view. In the same drawing, it is confirmed that the wax W transferred to the medium S is changed to the thin film-like layer Wb (for example, a layer having a thickness of about 0.1 μm in a circular region having a diameter of 30 μm) that is smoothly thinly spread in a flattened manner by the rubbing processing using the post-processing device 25. In this case, in the thin film-like layer Wb, there is no scattering as in the granular mass Wa, and the wax is in a less visible state. Therefore, a case where the wax transferred to the medium S may be manifested as surface contamination is effectively suppressed.

### Example 2

Example 2 is to confirm the effectiveness of the rubbing processing using the post-processing device 25 by using the post-processing device 25 of the image forming system 20 according to Exemplary Embodiment 1 or 2.

In the present example, a film medium (for example, OZK-E188A manufactured by DYNIC CORPORATION) of which the surface is smooth is used as the medium S, and for a plurality of medium samples having different visual grades, a post-processing state with respect to the wax transfer is examined, and whether or not the wax is less visible is visually confirmed.

Here, in examining the post-processing state of the medium S, the thickness tr (wax layer thickness) of the thin film-like layer Wb of the wax is measured, and the boundary value of the thickness tr at which the wax of the medium S can be made less visible is obtained.

In the present example, as the measurement method, a method of calculating a height of the wax particles on the medium by averaging maximum heights (corresponding to maximum thicknesses) of a plurality of wax particles existing in a certain measurement region using an optical microscope is adopted. In obtaining the average of the maximum heights, the sum of the maximum heights of the wax particles in the measurement region is divided by the number of particles.

Measurement conditions are as follows.
Optical microscope: KEYENCE VK-X3000
Measurement method: laser irradiation method
Magnification: 500 times
Scan mode: laser confocal
Measurement region: 0.2 mm×0.2 mm
Measurement size: standard (1024×768) knitting
Measurement quality setting: high accuracy
Measurement pitch setting: 0.13 μm

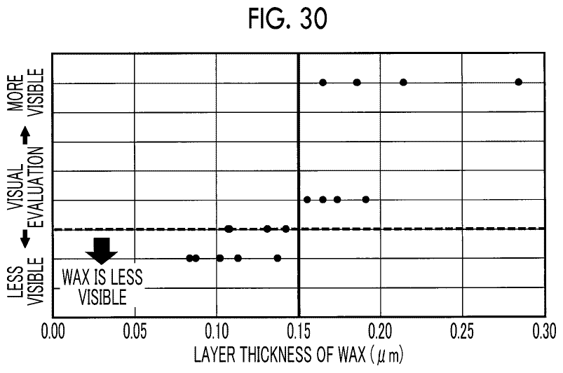

In the present example, in a case where a correlation between the calculated average height of the wax particles (corresponding to the layer thickness of the wax) and the visual grade is graphed, a result shown in FIG. 30 is obtained.

As seen from the same drawing, the wax is less visible in a case where the wax layer thickness is equal to or less than 0.15 μm.

### Example 3

In the present example, the post-processing device according to Exemplary Embodiment 3 is used to evaluate the rubbing operation effect.

In the present example, the knitted fabric structure is adopted as the rubbing portions 94 of the first rubbing roll 91 and the second rubbing roll 92, and the rubbing operation on the wax is performed under predetermined rubbing conditions.

### Comparative Example 1

In Comparative Example 1, felt is used as the rubbing portions 94 of the first rubbing roll 91 and the second rubbing roll 92, and the rubbing operation on the wax is performed under the same rubbing condition as in Example 1.

### Comparative Example 2

In Comparative Example 2, a towel (nap-raised cloth) is used as the rubbing portions 94 of the first rubbing roll 91 and the second rubbing roll 92, and the rubbing operation on the wax is performed under the same rubbing condition as in Example 1.

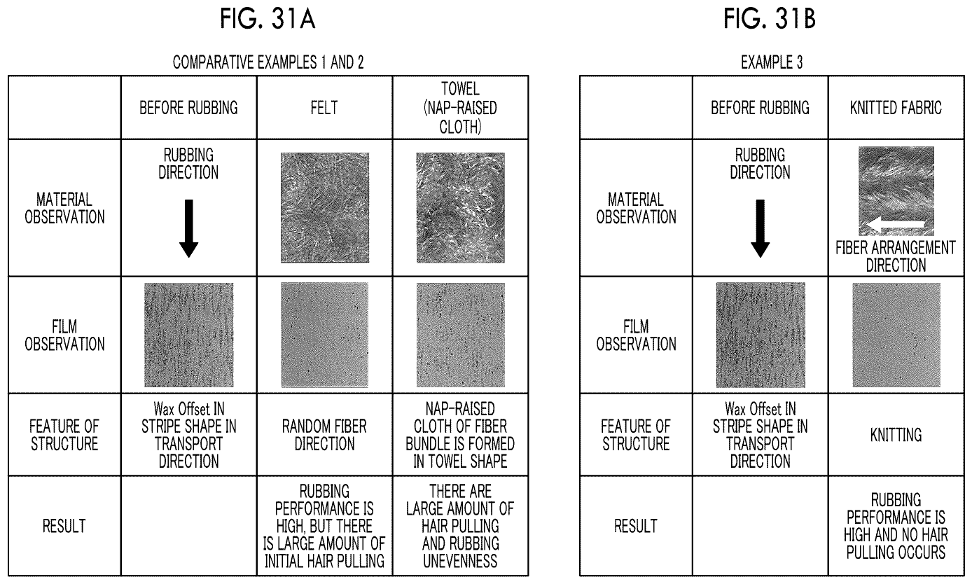

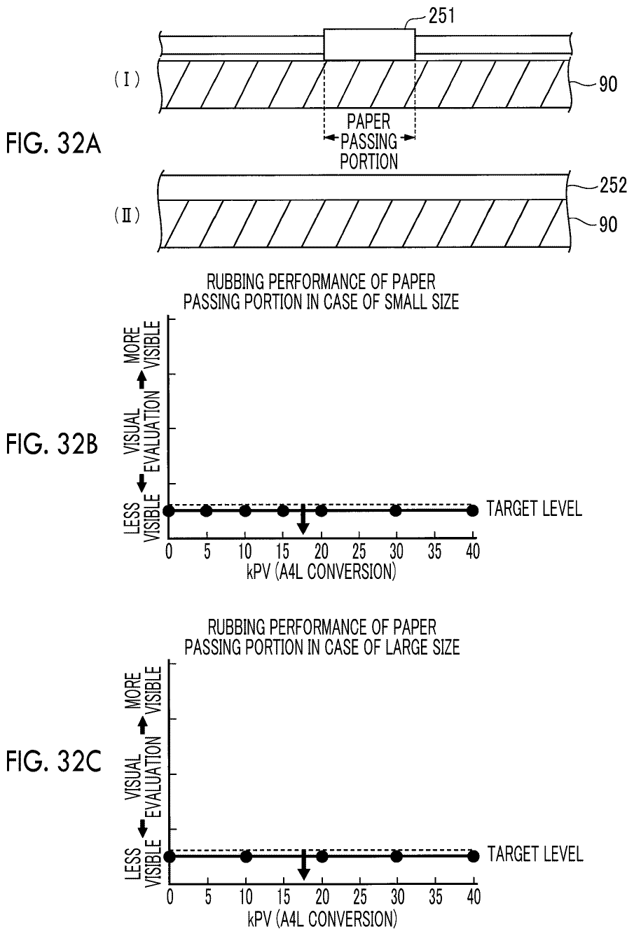

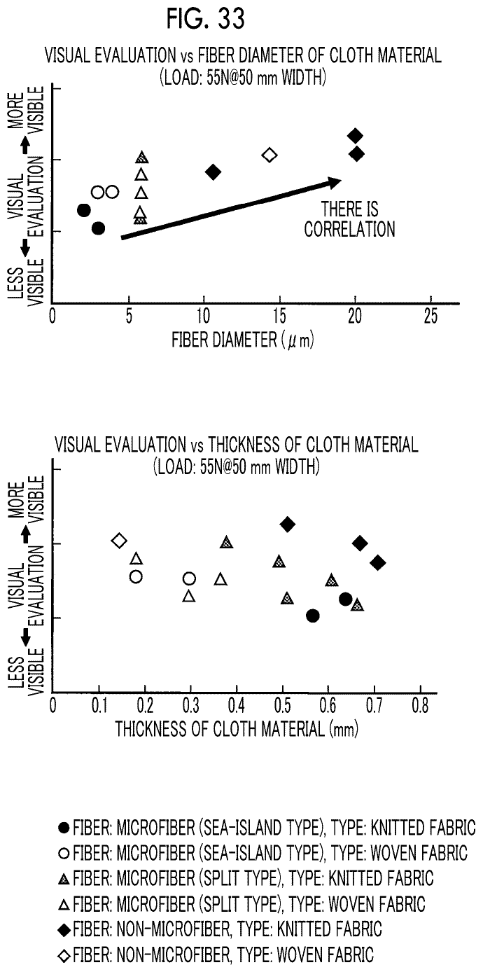

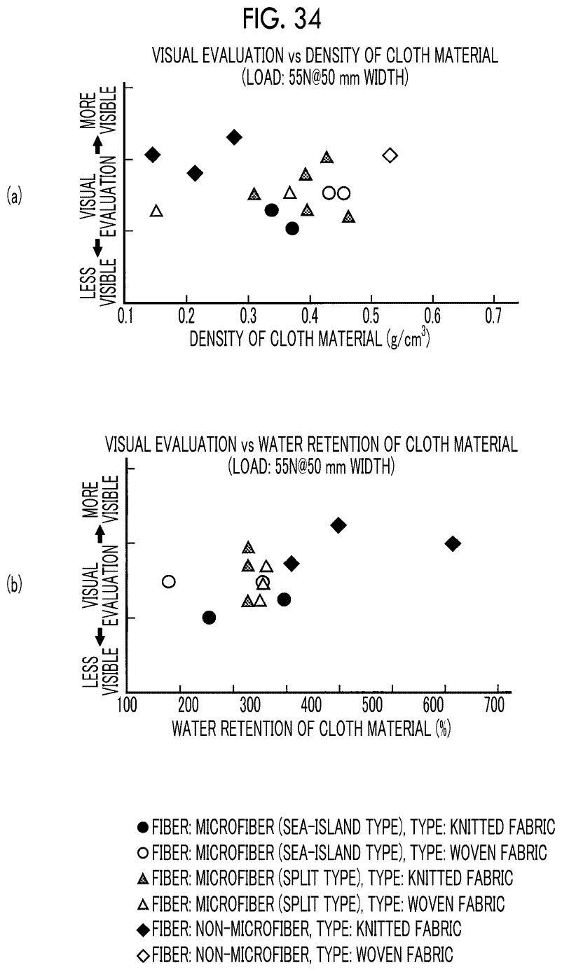

The results of Comparative Examples 1 and 2 are shown in FIG. 31A, and the results of Example 3 are shown in FIG. 31B.

According to the present example, the rubbing performance on the wax on the medium is high, no rubbing unevenness is observed, and no hair pulling of the cloth material is observed at all. In Example 3, in a case where the same rubbing operation on the wax is performed in the aspect in which the woven fabric structure is used as the rubbing portion 94, good results are obtained similarly to Example 3.

On the other hand, in Comparative Example 1, the rubbing performance with respect to the wax on the medium is high, but hair pulling of the felt as the rubbing portion 94 is frequently observed.

In Comparative Example 2, rubbing unevenness is observed on the wax on the medium, and a large amount of hair pulling is observed on the towel.

### Example 4

In Example 4, the durability of the rubbing operation on the wax is examined by using the rubbing roll 90 of the post-processing device according to Exemplary Embodiment 1.

FIG. 32A is an example of a test device that examines the durability.

In (I) of FIG. 32A, the transport roll 251 having a large diameter is disposed only at a location corresponding to the paper passing portion facing the rubbing roll 90 according to Example 4 such that paper as the medium having a small width dimension (50 mm width) is made to run.

In (II) of FIG. 32A, the transport roll 252 having the same diameter in the axial direction is disposed to face the rubbing roll 90 according to Example 4 such that the paper as a large-sized (A4 longitudinal direction width: A5L) medium is made to run.

In the test device of the present example, as the rubbing roll 90, the cloth material (CAR-T150: fiber diameter of 5 μm) having a thickness of 0.7 mm is wound around a shaft having a diameter of 200 via an elastic layer made of silicone rubber having a thickness of 5 mm. The load on the rubbing roll 90 is set to 8.5 kgf. Further, the circumferential speed of the rubbing roll 90 is set to 1240 mm/s with respect to the paper speed of 177 mm/s.

In the present example, the test device shown in (I) of FIG. 32A is used, an image that has passed through the fixing device and small-sized paper to which the wax adheres are continuously run, and the rubbing operation on the wax using the rubbing roll 90 is evaluated.

The results are shown in FIG. 32B. In the same drawing, in a case where an amount of paper is converted into A4L, the rubbing operation on the wax is repeated until the 40 kPV, but it is confirmed that the wax transfer level (visual evaluation) of the wax remaining on the paper after the post-processing is in a good state within a target level.

Similarly, the test device in (II) of FIG. 32A is used, the image that has passed through the fixing device and the medium to which the wax adheres are continuously run, and the rubbing operation on the wax using the rubbing roll 90 is evaluated.

The results are shown in FIG. 32C. In the same drawing, the rubbing operation on the wax is repeated until 40 kPV even on large-sized paper, but it is confirmed that the wax transfer level (visual evaluation) of the wax remaining on the paper is in a good state within the target level.

### Example 5

In the present example, the rubbing performance with respect to the wax is evaluated by the rubbing roll including the rubbing portion made of the cloth material having the plurality of fibers (six types in the present example) using the test device shown in (I) of FIG. 32A.

In the present example, as the six types of fibers, sea-island type microfiber (knitted fabric structure), sea-island type microfiber (woven fabric structure), split type microfiber (knitted fabric structure), split type microfiber (woven fabric structure), non-microfiber (knitted fabric structure), and non-microfiber (woven fabric structure) are used.

In the present example, as the rubbing condition, the load of the rubbing roll is set to 55 N, and the rubbing roll performs the wax rubbing operation on the wax on the paper as a small-sized (50 mm width) medium.

In this case, as the physical property parameters of the cloth material, a relationship between the fiber diameter, the thickness, the density, the water retention, and the wax transfer level on the paper after the post-processing is examined.
(a) of FIG. 33 shows a relationship between the fiber diameter of the cloth material and the wax transfer level (visual evaluation). In the same drawing, it is understood that the smaller the fiber diameter of the fiber material of the cloth material, the better the wax transfer level (visual evaluation).
(b) of FIG. 33 shows a relationship between the thickness of the cloth material and the wax transfer level (visual evaluation).
(a) of FIG. 34 shows a relationship between the density of the cloth material and the wax transfer level (visual evaluation).
(b) of FIG. 34 shows a relationship between the water retention of the cloth material and the wax transfer level (visual evaluation).

According to (b) of FIG. 33, (a) of FIG. 34, and (b) of FIG. 34, it is understood that there is no particular correlation between the thickness, the density, the water retention, and the wax transfer level (visual evaluation) of the cloth material.

### SUPPLEMENTARY NOTE

(((1)))

A post-processing device comprising:
a transport section that transports a medium, on which an image formed using an imaging material and wax are held and which has passed through a fixing section that fixes the image of the medium by heating and pressurization, at a predetermined speed by nipping the medium; and
a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section,
wherein the rubbing section has, at least on a surface, a rubbing portion in which fibers are arranged in a regular pattern in a direction intersecting the transport direction of the medium, and the rubbing portion comes into contact with the surface of the medium with portions of the fibers other than end portions.
   (((2)))

The post-processing device according to (((1))),
wherein the rubbing section includes, at least on the surface, a rubbing portion in which one or a plurality of fibers extending in the direction intersecting the transport direction of the medium are arranged in a regular pattern, and the rubbing portion comes into contact with the surface of the medium with portions of the fibers extending in a length direction.
   (((3)))

The post-processing device according to (((1))) or (((2)))
wherein the rubbing section includes, at least on the surface, a rubbing portion in which fiber bundles each formed by bundling a plurality of fibers extending in the direction intersecting the transport direction of the medium are arranged in a regular pattern, and the rubbing portion comes into contact with the surface of the medium with the plurality of fibers of the fiber bundle.
   (((4)))

The post-processing device according to (((1))),
wherein the rubbing section includes, at least on the surface, a rubbing portion in which loop-shaped fibers are closely arranged in a regular pattern in the direction intersecting the transport direction of the medium, and the rubbing portion comes into contact with the surface of the medium with protruding end portions of the loop-shaped fibers.
   (((5)

The post-processing device according to (((3))) or (((4)
wherein the rubbing section includes, at least on the surface, a rubbing portion in which a plurality of rows of loop-shaped fibers are alternately and closely arranged in a regular pattern in the direction intersecting the transport direction of the medium, and the rubbing portion comes into contact with the surface of the medium with protruding end portions of at least two rows of loop-shaped fibers.
   (((6))

The post-processing device according to any one of (((1))) to (5)),
wherein the rubbing section is elastically biased against the medium.
   (((7)))

The post-processing device according to (((6))),
wherein the rubbing section includes the rubbing portion on a substrate via an elastic layer.
   (((8)))

The post-processing device according to any one of (((1))) to (((7))),
wherein the rubbing section includes a rubbing portion having a woven fabric structure woven by combining yarns each consisting of warp and weft fibers.
   (((9))

The post-processing device according to any one of (((1))) to (((7)),
wherein the rubbing section includes a rubbing portion having a knitted fabric structure composed of continuous meshes.
   (((10)))

The post-processing device according to any one of (((1))) to (((9))),
wherein a fiber diameter of the rubbing section is larger than a wax height before post-processing.
   (((11)))

The post-processing device according to any one of (((1))) to (((10))),
wherein a fiber diameter of the rubbing section is smaller than a wax length before post-processing.
   (((12)))

The post-processing device according to any one of (((1)
wherein the rubbing section includes a rubbing portion consisting of microfibers having a fiber diameter of less than 10 μm.
   (((13)))

The post-processing device according to any one of (((1))) to (((12))),
wherein the rubbing section includes
   a rotating body that is disposed to face the medium, and
   a belt-shaped member that is wound around the rotating body in a spiral shape, and
the belt-shaped member has the rubbing portion formed in advance on a surface side.
   (((14)))

The post-processing device according to (((13))),
wherein the belt-shaped member has a rubbing portion consisting of a woven fabric structure or a knitted fabric structure using fibers.
   (((15)))

The post-processing device according to any one of (((1))) to (((14)))
wherein the rubbing section consists of a plurality of rotating bodies that are disposed to face each other with respect to the medium and that are able to come into contact with each other and separable from each other between a contact position at which the plurality of rotating bodies are in contact with the medium and a non-contact position, and rubs the surface of the medium in a case where the plurality of rotating bodies are disposed at the contact position.
   (((16)))

The post-processing device according to (((15))),
wherein, in a case where the plurality of rotating bodies constituting the rubbing section are disposed at the contact position, a frictional force between the transport section and the medium is greater than a frictional force between the rubbing section and the medium.
   (((17)))

The post-processing device according to (((15))),
wherein the plurality of rotating bodies constituting the rubbing section are disposed at the contact position in a case where the transport section transports the medium, and are disposed at the non-contact position in a case where the transport section does not transport the medium.
   (((18)))

An image forming system comprising:
an imaging section that holds an image, which is formed using an imaging material containing wax, on a medium;
a fixing section that performs heating and pressurization to fix the image, which is formed by the imaging section, on the medium; and
the post-processing device according to any one of (((1))) to (((17))) that performs post-processing on the medium that has passed through the fixing section.
   (((19)))

A rubbing component used in a configuration of a post-processing device together with a transport section that transports a medium, on which an image formed using an imaging material and wax are held and which has passed through a fixing section that fixes the image of the medium by heating and pressurization, at a predetermined speed by nipping the medium,
the rubbing component being located upstream or downstream of the transport section in a transport direction of the medium and rubbing a surface of the medium such that a layer thickness after passage of the wax held on the surface of the medium is reduced, in a case where the medium transported by the transport section passes through the rubbing component, the rubbing component comprising:
at least on a surface, a rubbing portion in which fibers are arranged in a regular pattern in a direction intersecting the transport direction of the medium,
wherein the rubbing portion comes into contact with the surface of the medium with portions of the fibers other than end portions.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A post-processing device comprising:
a transport section that transports a medium, on which an image formed using an imaging material and wax are held and which has passed through a fixing section that fixes the image of the medium by heating and pressurization, at a predetermined speed by nipping the medium; and
a rubbing section that is located upstream or downstream of the transport section in a transport direction of the medium and that rubs a surface of the medium such that a layer thickness after passage of the wax held on the surface of the medium is reduced, in a case where the medium transported by the transport section passes through the rubbing section,
wherein the rubbing section has, at least on a surface, a rubbing portion in which fibers are arranged in a regular pattern in a direction intersecting the transport direction of the medium, and the rubbing portion comes into contact with the surface of the medium with portions of the fibers other than end portions.

2. The post-processing device according to claim 1,
wherein the rubbing section includes, at least on the surface, a rubbing portion in which one or a plurality of fibers extending in the direction intersecting the transport direction of the medium are arranged in a regular pattern, and the rubbing portion comes into contact with the surface of the medium with portions of the fibers extending in a length direction.

3. The post-processing device according to claim 2,
wherein the rubbing section includes, at least on the surface, a rubbing portion in which fiber bundles each formed by bundling a plurality of fibers extending in the direction intersecting the transport direction of the medium are arranged in a regular pattern, and the rubbing portion comes into contact with the surface of the medium with the plurality of fibers of the fiber bundle.

4. The post-processing device according to claim 1,
wherein the rubbing section includes, at least on the surface, a rubbing portion in which loop-shaped fibers are closely arranged in a regular pattern in the direction intersecting the transport direction of the medium, and the rubbing portion comes into contact with the surface of the medium with protruding end portions of the loop-shaped fibers.

5. The post-processing device according to claim 4,
wherein the rubbing section includes, at least on the surface, a rubbing portion in which a plurality of rows of loop-shaped fibers are alternately and closely arranged in a regular pattern in the direction intersecting the transport direction of the medium, and the rubbing portion comes into contact with the surface of the medium with protruding end portions of at least two rows of loop-shaped fibers.

6. The post-processing device according to claim 1,
wherein the rubbing section is elastically biased against the medium.

7. The post-processing device according to claim 6,
wherein the rubbing section includes the rubbing portion on a substrate via an elastic layer.

8. The post-processing device according to claim 1,
wherein the rubbing section includes a rubbing portion having a woven fabric structure woven by combining yarns each consisting of warp and weft fibers.

9. The post-processing device according to claim 1,
wherein the rubbing section includes a rubbing portion having a knitted fabric structure composed of continuous meshes.

10. The post-processing device according to claim 1,
wherein a fiber diameter of the rubbing section is larger than a wax height before post-processing.

11. The post-processing device according to claim 1,
wherein a fiber diameter of the rubbing section is smaller than a wax length before post-processing.

12. The post-processing device according to claim 1,
wherein the rubbing section includes a rubbing portion consisting of microfibers having a fiber diameter of less than 10 μm.

13. The post-processing device according to claim 1,
wherein the rubbing section includes
a rotating body that is disposed to face the medium, and
a belt-shaped member that is wound around the rotating body in a spiral shape, and
the belt-shaped member has the rubbing portion formed in advance on a surface side.

14. The post-processing device according to claim 13,
wherein the belt-shaped member has a rubbing portion consisting of a woven fabric structure or a knitted fabric structure using fibers.

15. The post-processing device according to claim 1,
wherein the rubbing section consists of a plurality of rotating bodies that are disposed to face each other with respect to the medium and that are able to come into contact with each other and separable from each other between a contact position at which the plurality of rotating bodies are in contact with the medium and a non-contact position, and rubs the surface of the medium in a case where the plurality of rotating bodies are disposed at the contact position.

16. The post-processing device according to claim 15,
wherein, in a case where the plurality of rotating bodies constituting the rubbing section are disposed at the contact position, a frictional force between the transport section and the medium is greater than a frictional force between the rubbing section and the medium.

17. The post-processing device according to claim 15,
wherein the plurality of rotating bodies constituting the rubbing section are disposed at the contact position in a case where the transport section transports the medium, and are disposed at the non-contact position in a case where the transport section does not transport the medium.

18. An image forming system comprising:
an imaging section that holds an image, which is formed using an imaging material containing wax, on a medium;
a fixing section that performs heating and pressurization to fix the image, which is formed by the imaging section, on the medium; and
the post-processing device according to claim 1 that performs post-processing on the medium that has passed through the fixing section.

19. An image forming system comprising:
an imaging section that holds an image, which is formed using an imaging material containing wax, on a medium;
a fixing section that performs heating and pressurization to fix the image, which is formed by the imaging section, on the medium; and
the post-processing device according to claim 2 that performs post-processing on the medium that has passed through the fixing section.

20. A rubbing component used in a configuration of a post-processing device together with a transport section that transports a medium, on which an image formed using an imaging material and wax are held and which has passed through a fixing section that fixes the image of the medium by heating and pressurization, at a predetermined speed by nipping the medium,
the rubbing component being located upstream or downstream of the transport section in a transport direction of the medium and rubbing a surface of the medium such that a layer thickness after passage of the wax held on the surface of the medium is reduced, in a case where the medium transported by the transport section passes through the rubbing component, the rubbing component comprising:
at least on a surface, a rubbing portion in which fibers are arranged in a regular pattern in a direction intersecting the transport direction of the medium,
wherein the rubbing portion comes into contact with the surface of the medium with portions of the fibers other than end portions.
